(19) United States
(12) Patent Application Publication
(10) Pub. No.: US 2020/0036271 A1
(43) Pub. Date: Jan. 30, 2020

(54) Brushless Doubly Fed Radial Wound Electric Machine

(71) Applicant: Roy Michael Kies, Greenfield, WI (US)

(72) Inventor: Roy Kies, Greenfield, WI (US)

(73) Assignee: Roy Michael Kies, Greenfield, WI (US)

(21) Appl. No.: 16/045,674

(22) Filed: Jul. 25, 2018

(51) Int. Cl. H02K 21/46; H02K 5/18; H02K 11/21; H02K 11/27; H02K 16/02; H02K 16/04; H02K 15/04

(52) U.S. Cl. CPC H02K 21/46; H02K 5/18; H02K 11/21; B60L 15/2036; H02K 16/02; H02K 16/04; H02K 15/045; H02K 11/27

(57) ABSTRACT

A strip of laminating steel for electric motors or generators is rolled over a mandrel in order to create an electric motor rotor or stator. The outside diameter of the mandrel determines the inside diameter of the roll, while the length of the strip determines the outside diameter of the roll. Slots for the insertion of magnet wire are either precut into the sides of the strip, or cut into the sides of the roll with metal working machinery after the roll has been wound. The slots can be created on one or both sides of the roll. Inserting magnet wire coils in these slots creates a rotor or a stator for an electric machine. A rotor surrounded by two identical stators with their stator windings facing the two rotor sides, or a stator containing slots on both sides which share one winding in its stator slots surrounded by two identical rotors comprise the main components.

### DETAILED DESCRIPTION OF THE INVENTION

Rotors and stators of conventional electric motors and generators are created by cutting out multiple circular rotor and stator profiles from a sheet of laminating steel. These profiles are then stacked and properly aligned to form a stator stack or a rotor stack. Stator stacks are usually welded together on their outer periphery, and then installed in their proper location inside the motor. The rotor stack is usually installed in its proper location on the shaft.

One of the purposes of this invention is to reduce the excessive amount of magnet wire required at both ends of the standard stator core of a conventional two pole motor and many four or more pole motors; and also to provide either two stators surrounding a common rotor or two rotors surrounding a common stator. Another benefit is the creation of a new type of multispeed motor. Additional benefits are also included.

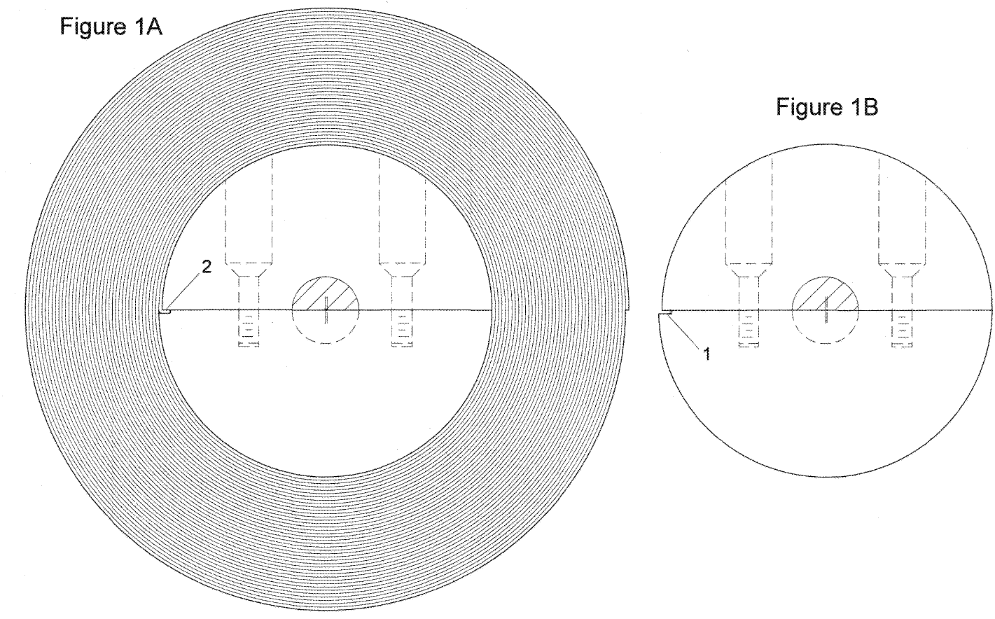

This invention uses a totally different technique for creating the rotor and stator of an electric motor. It involves using a long strip of laminating steel, the width of which has been cut to the desired axial width of the rotor or stator, and cut long enough so that when firmly wrapped over a mandrel as shown in FIGS. 1A or 1B, and then securely fastened down with epoxy or other fastening method so that it does not unravel, a roll of laminating steel strip with the desired inside and outside diameter is created.

FIG. 1A shows a bolted or screwed type of split mandrel. The upper semicircular half of the mandrel is reduced in diameter from that of the the lower semicircular half of the mandrel by the thickness of the laminating steel strip. The upper half of the mandrel has a full shaft extending from it toward the viewer for attachment to the winding device. When the lower half is bolted in position, the right side of the lower half is in line with the right side of the upper half. Because the diameter of the lower half is increased by the thickness of the laminate steel strip, the left side of the lower half extends beyond the left side of the upper half by this thickness.

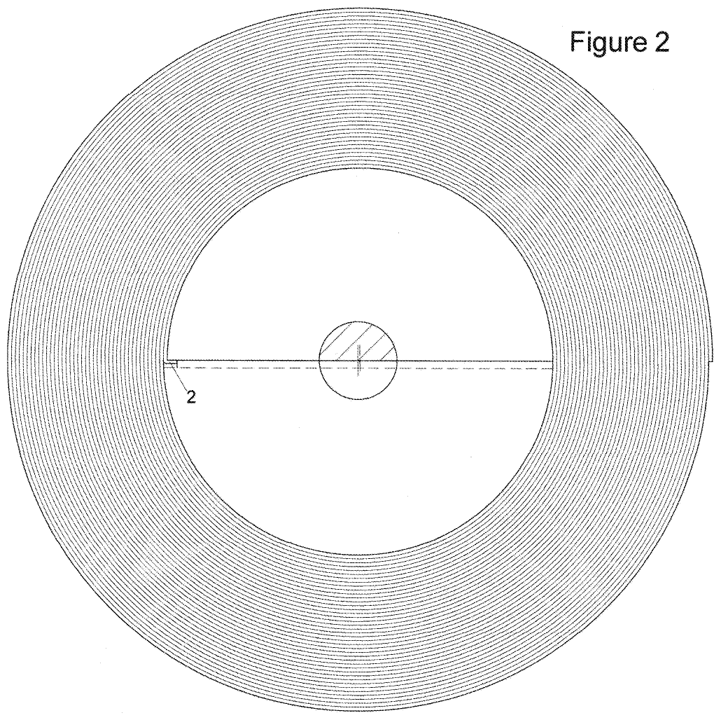

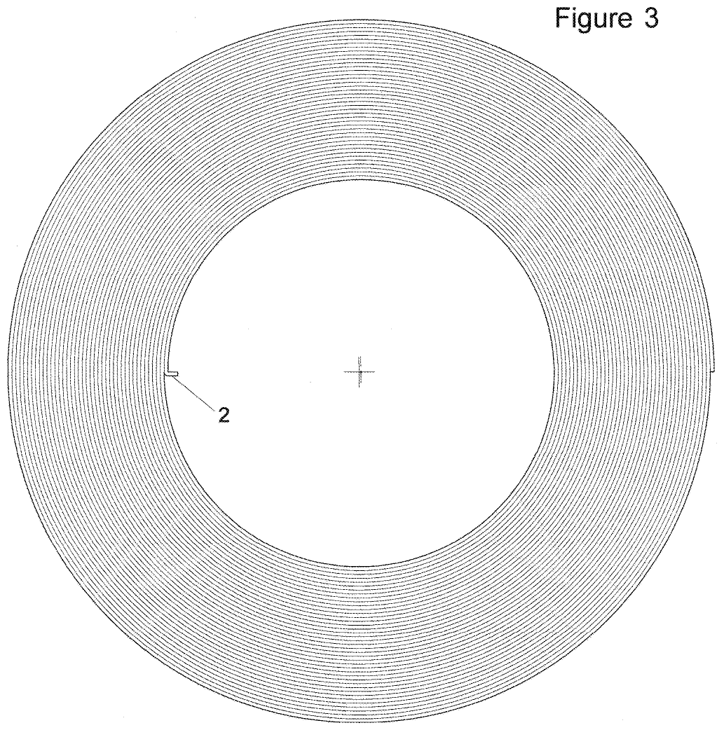

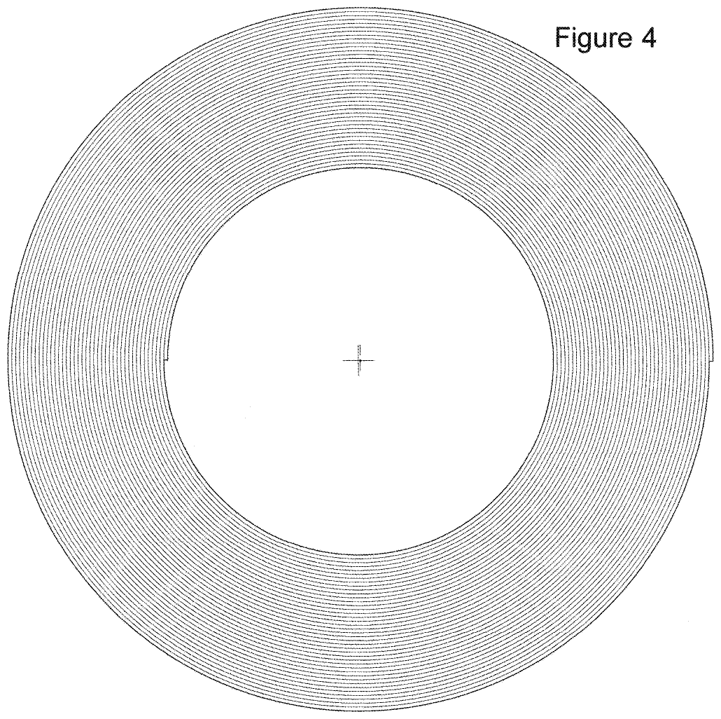

The laminating steel strip has a starting tab 2, FIGS. 1A, 2 and 3, formed at a right angle towards the center, which is inserted in the slot 1, FIG. 1B, that was created for this purpose. This strip is then wound around the mandrel one complete turn, after which the upper part of the strip is epoxied to the turn beneath it in order to prevent it from unraveling. Ideally, a small amount of epoxy or other adhesive should be applied to the underside of the laminate steel strip for its entire length with tension maintained on this laminating steel strip until the epoxy has cured. Once cured, the strip can be cut off at its required length, which is an additional one half turn on the upper outside half and an additional one half turn on the upper inside of this laminated steel core (see FIG. 2). Removing the starting tab 2, FIG. 3, completes the first step in the creation of this rolled laminating steel strip core 4, as shown in FIG. 4.

This rolled laminating steel strip core 4, FIG. 1 and elsewhere, will also be referred to as a “rolled strip core”, or “rolled strip”.

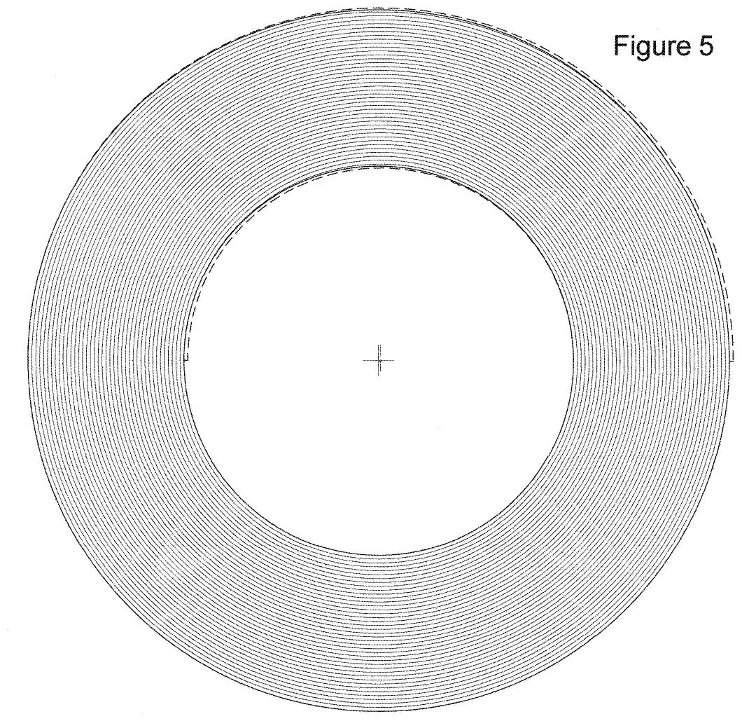

The reason for adding the above mentioned one half turn is illustrated in FIG. 5. The area contained between the inside full circle and the outside full circle of FIG. 5 represents the actual working area of this rolled strip core. The additional one half turn on the outside and inside of the core is necessary to assure that all of the actual working area contains laminating steel strip. Using a lathe or similar tool to cut away the waste shown in FIG. 5 completes the creation of a rolled strip core.

FIG. 2 shows another type of mandrel design, which is similar to FIG. 1, except that the dashed horizontal line represents the location of the split at the back side of this mandrel. The two mandrel halves are cut with a slight taper from front to rear in order to facilitate easier removal of the mandrel by removing the screws, then driving the lower half of the mandrel towards the viewer, or driving the upper half of the mandrel away from the viewer.

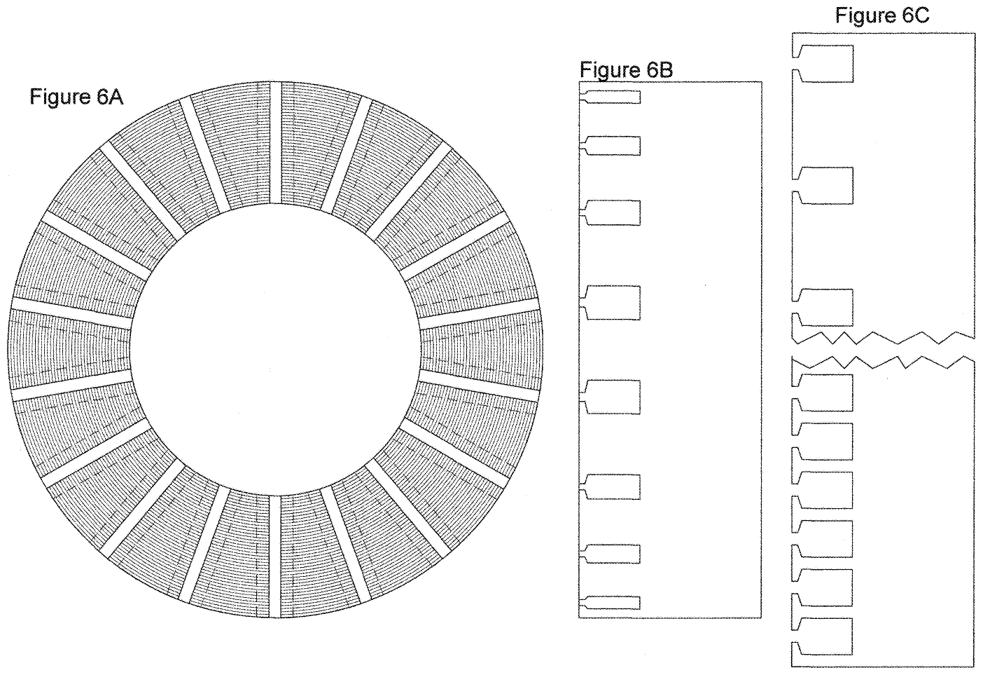

The rolled strip core, FIGS. 4 and 5, are drawings which shows the rear view of this rolled strip core. The front view of this rolled strip core, FIGS. 4 and 5, is shown in FIG. 6A, which has slots cut into it's face in order to accept magnet wire (typically for winding stators), or to accept molten metal (typical for casting squirrel cage windings in rotors). This rolled strip core is firmly anchored in place to prevent rotation when used as a stator, or is firmly anchored to the shaft to allow rotation when used as a rotor. FIG. 6B is a side view of FIG. 6A.

The bottom drawing of FIG. 6C shows the beginning of the laminating steel strip, while the top drawing of FIG. 6C shows the end of the laminating steel strip. The slots in the bottom drawing of FIG. 6C are very close together because they are near the inside of the rolled strip core while the slots at the top drawing of FIG. 6C are much farther apart in order to create the straight radial slots shown in FIG. 6A. These slots are cut out of the laminating steel strip before the laminating steel strip is wound on the mandrel.

Another technique for creating slots in the rolled laminating steel strip core is to completely cover the surfaces of the bare (not slotted) laminating steel strip with a bonding agent such as epoxy, then winding this epoxy coated strip tightly around the mandrel, all the while maintaining tension on the strip until the bonding agent cures.

The objective of this technique is to produce a laminated steel strip core so rigid that it can be machined by metal working machinery. In this way, slots for the windings can be cut into the face of the laminated steel strip core after this core is wound and cured, thereby providing an alternative method for producing the winding's slots in the laminating steel strip core.

A different procedure which will be called “back wrapping” will be used to reduce the amount of magnet wire that is not within the slot of the rolled strip core. With this new procedure, a measured length of magnet wire is passed through a given slot, then wrapped around the back side of the rolled strip core, then passed through the same slot a second time, and thereafter this back wrapping process is continued time after time until the total amount of turns required to be in the entire slot had been installed. A sufficient length of magnet wire needs to have been supplied at the beginning and end of the coil for making connections.

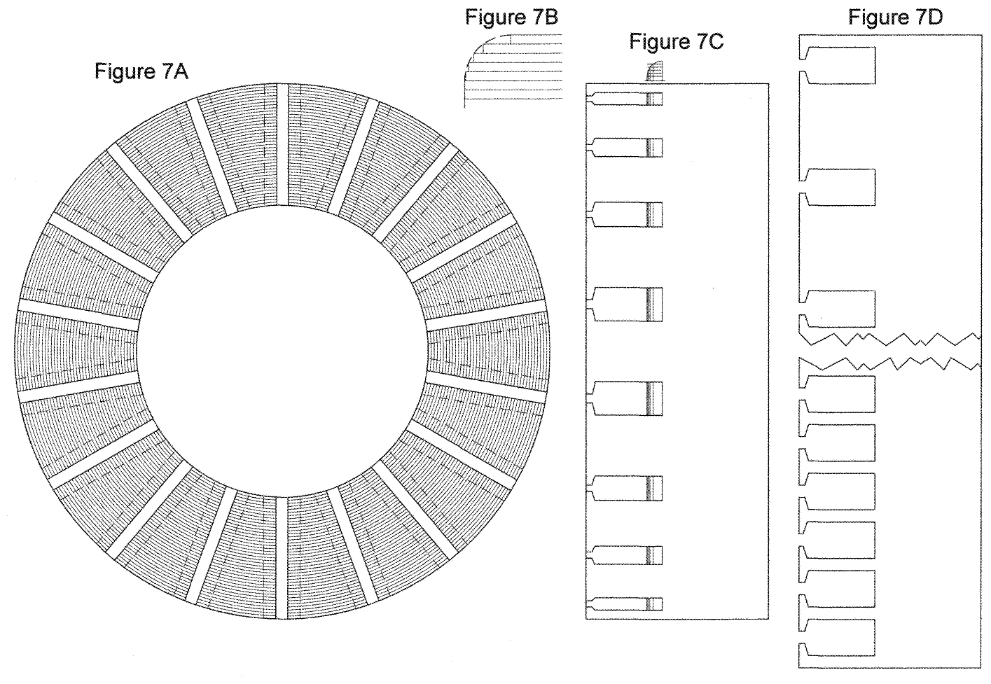

Figures of 7 and of figures of 8 show how the corners of a rolled strip core of FIG. 6 can be rounded to prevent the magnet wire from becoming damaged when back wrapped around them after slot insulation has been installed. FIG. 7A shows a front view of the rolled strip core. FIG. 7B shows how the slot can be made progressively deeper in order to create a rounded corner.

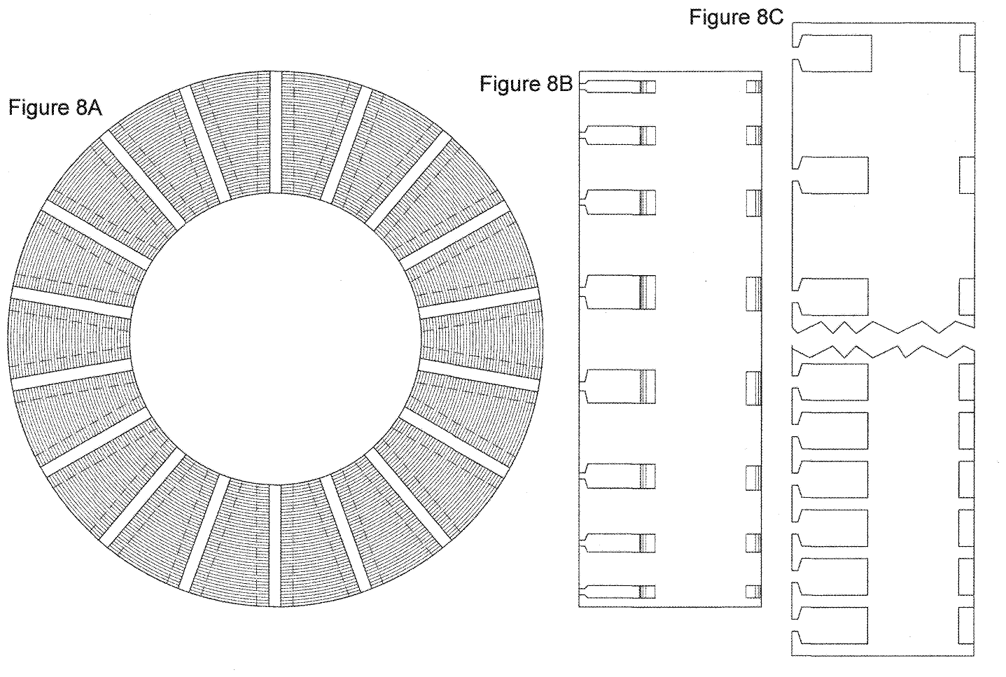

FIG. 7C shows a side view of FIG. 7A which has rounded corners only where the bottom of the slot and the outside layers of FIG. 7A meet, with the rounded corners visible in FIG. 7C. FIG. 7D shows the beginning (inside) of the rolled strip at the bottom of 7D, and the end of the rolled strip is shown at the top (outside) of FIG. 7D. In this drawing 7D, the beginning of the strip would have an extended depth slot at the inside of the rolled strip and would also have an extended depth slot on the outside of the rolled strip, as shown in FIG. 7D. FIG. 8A to 8C shows a similar drawing set where both the outside top and the outside bottom of the rolled strip core are rounded.

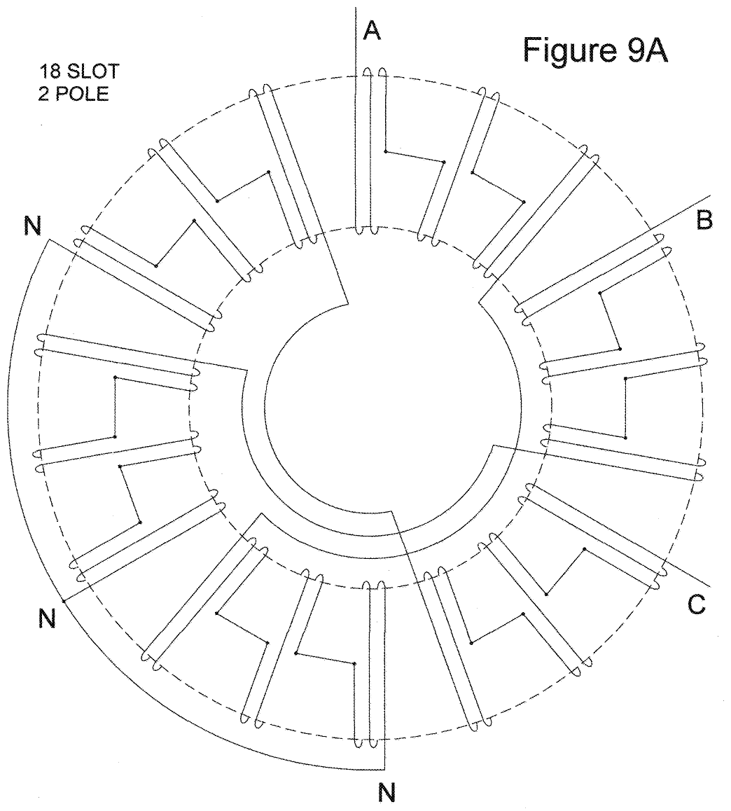

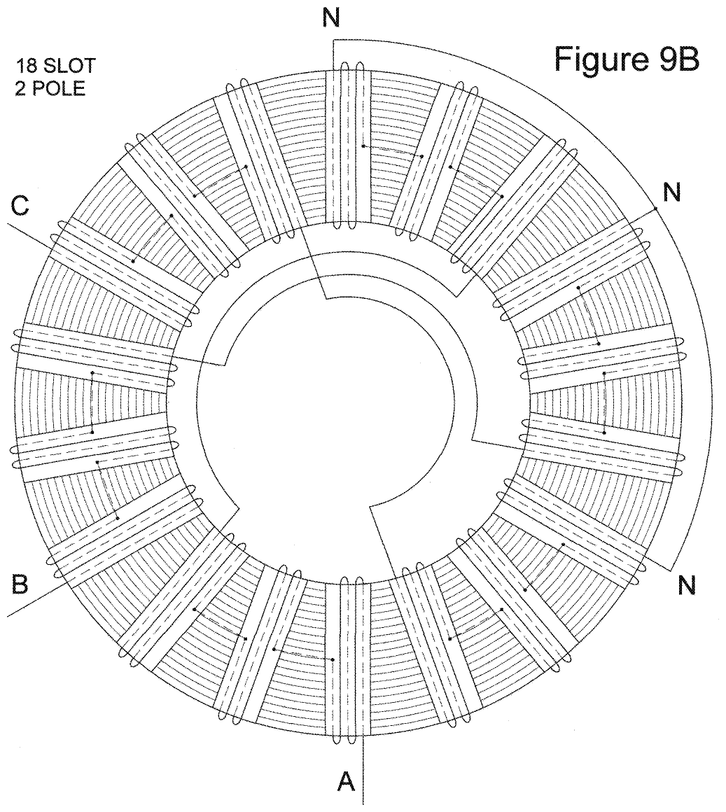

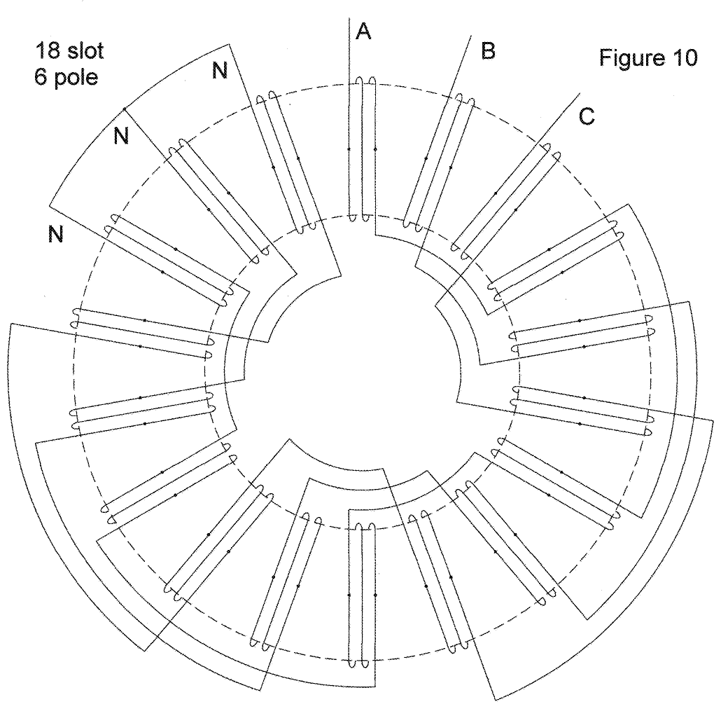

The dashed lines of FIGS. 9 through 14 are schematic representations of the backside of the rolled strip core. The solid lines of FIGS. 9 through 14 represent the magnet wires and the dots represent their connections. For instance, at the top of the drawings in FIG. 9A, magnet wire (fed from phase A) passes downward across the backside of the rolled strip core, then continues through the hole toward the front side, then passes upwards through the slot on the front side, then repeats wrapping around the backside and reentering the same front side slot once again, then passes over the top and drops halfway down the backside where a connection is made to the rest of the circuit. FIG. 9B shows the front side of FIG. 9A, with the magnet wires laid into their proper slots.

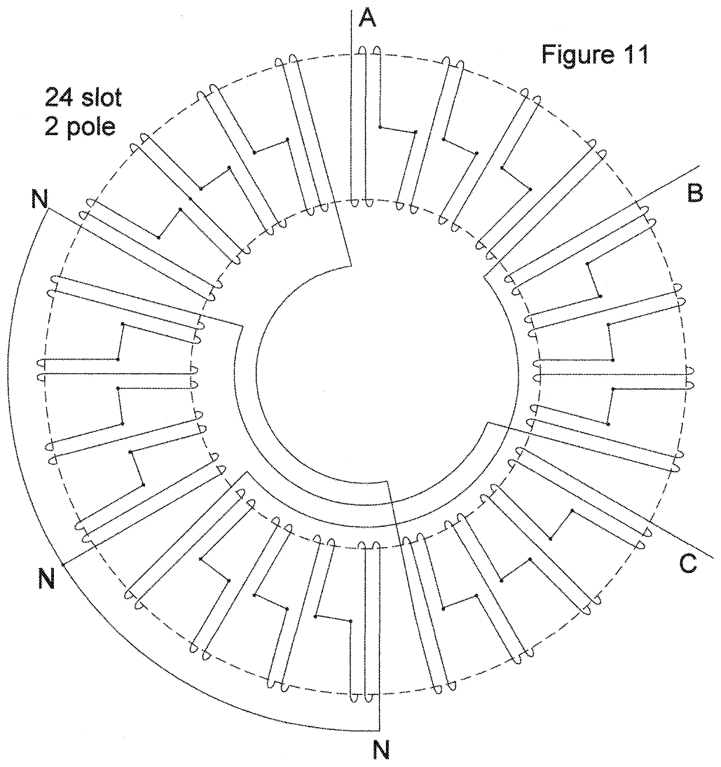

FIGS. 9A, 9B and 10, show two identical 18 slot rolled strip cores with identical windings installed in their slots, but connected differently. Comparing these two drawings reveal that by merely reconnecting the windings, it is sometimes possible to change a number of poles (which changes speed) of a polyphase motor or generator by using this back wrapping technique.

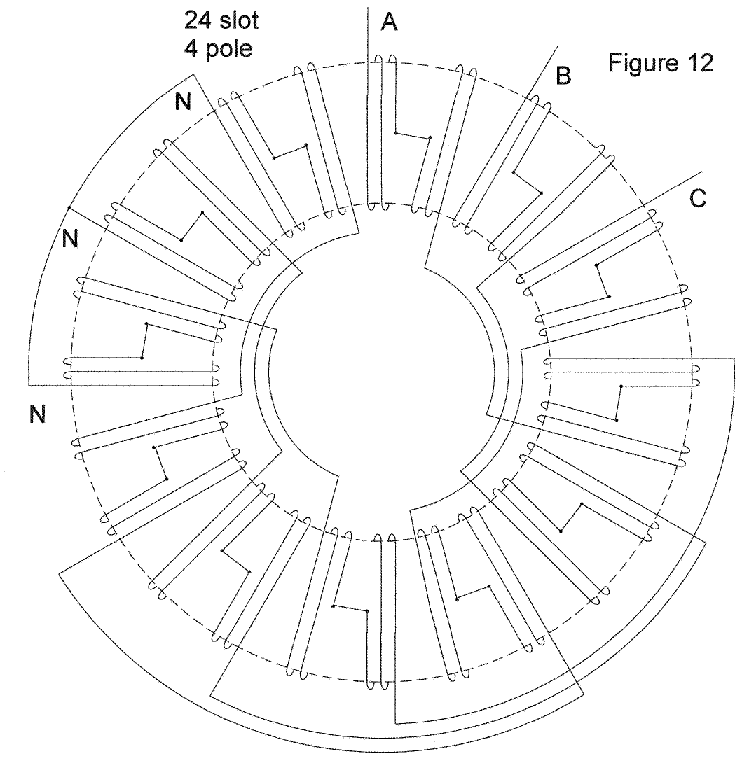

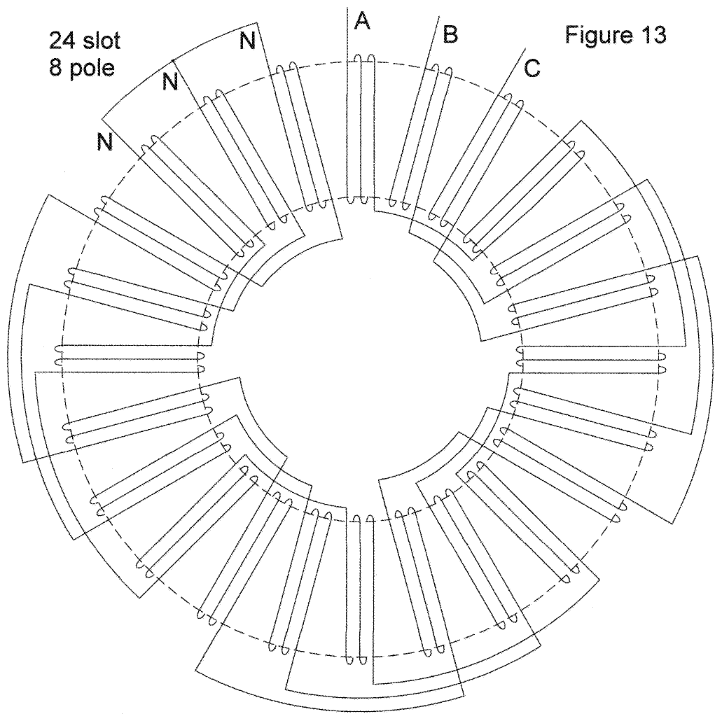

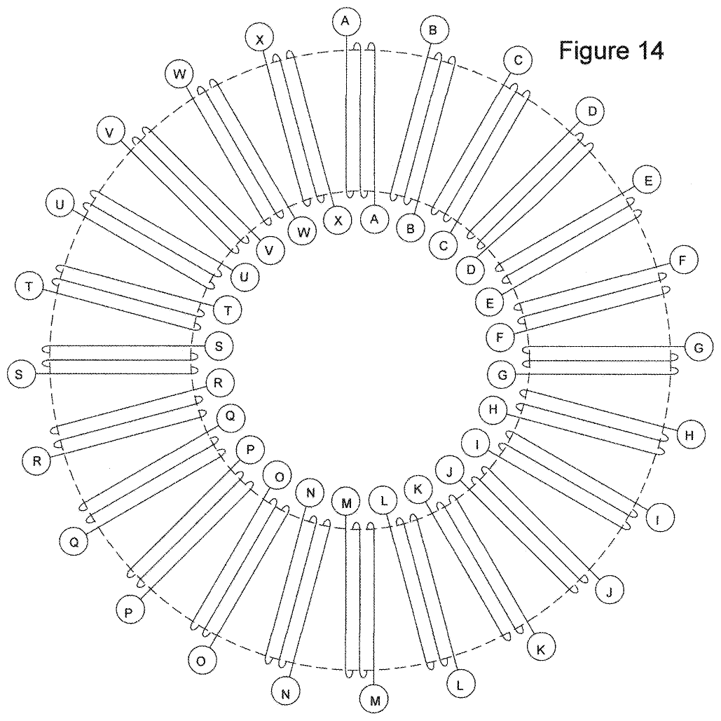

FIGS. 11, 12 & 13 show three identical 24 slot rolled strip cores with identical windings installed in their slots, but connected differently. Comparing these three drawings show that in this case, the same rolled strip core with its windings installed can be connected in three different ways to create a 2 pole, a 4 pole, or an 8 pole (3 speed) motor or generator.

Likewise, a 36 slot rolled strip core (not shown) can be created in the same manner and likewise connected in four different ways to create a 2 pole, a 4 pole, a 6 pole or a 12 pole (4 speed) motor or generator. Other combinations are also possible, especially with rolled strip cores which have more than 36 slots.

FIG. 14 shows the same 24 slot core as FIGS. 11 through 13 except that the windings are connected to identified terminals. When used as a motor, a motor controller can be connected to these terminals and can be designed to automatically reconnect the motor coils to agree with the speed called for by the motor controller. The motor controller could be programmed to start a motor at the slowest speed (greatest number of poles), and progressively switch to a higher speed (lesser number of poles) as the motor speed increases, until it reaches its selected speed. Such a motor control and rolled strip core motor combination would create more torque and draw less energy while starting, when compared with a conventional single speed controller with its single speed motor.

Back wrapping is not just limited to rolled strip cores. It can be applied to conventional motor or generator stators as well. Wrapping the winding around the backside (outside) of a conventional stator would often save magnet wire especially for two pole motors.

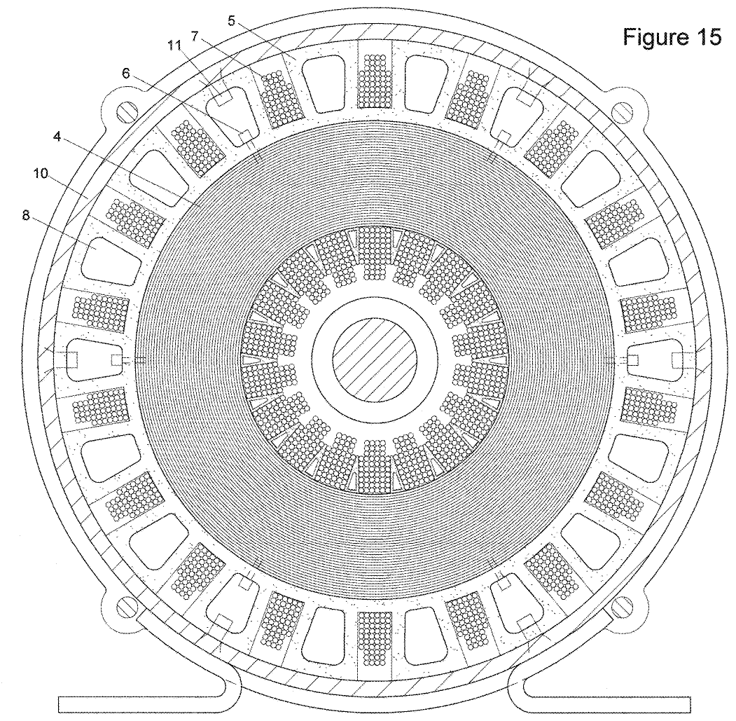

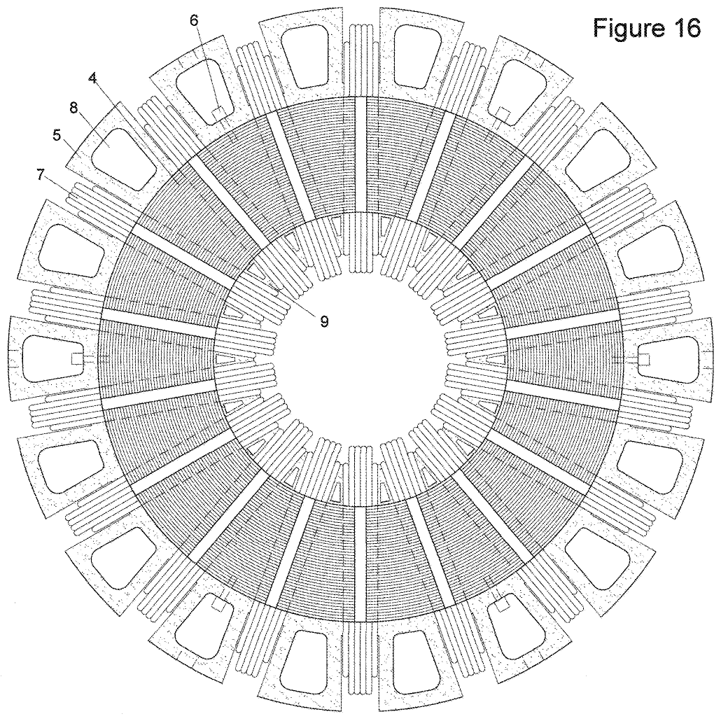

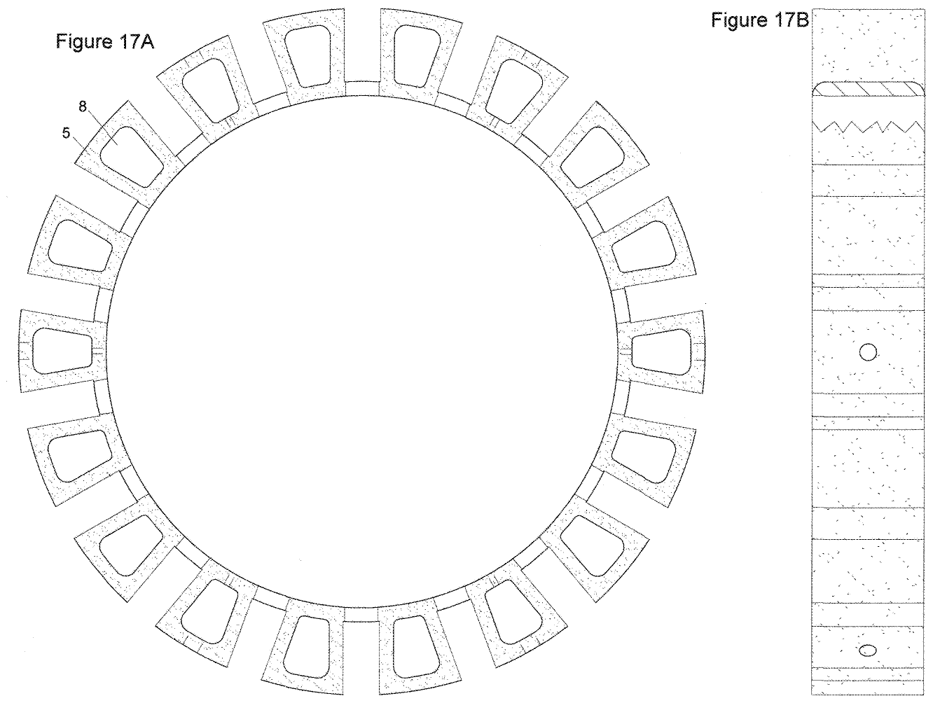

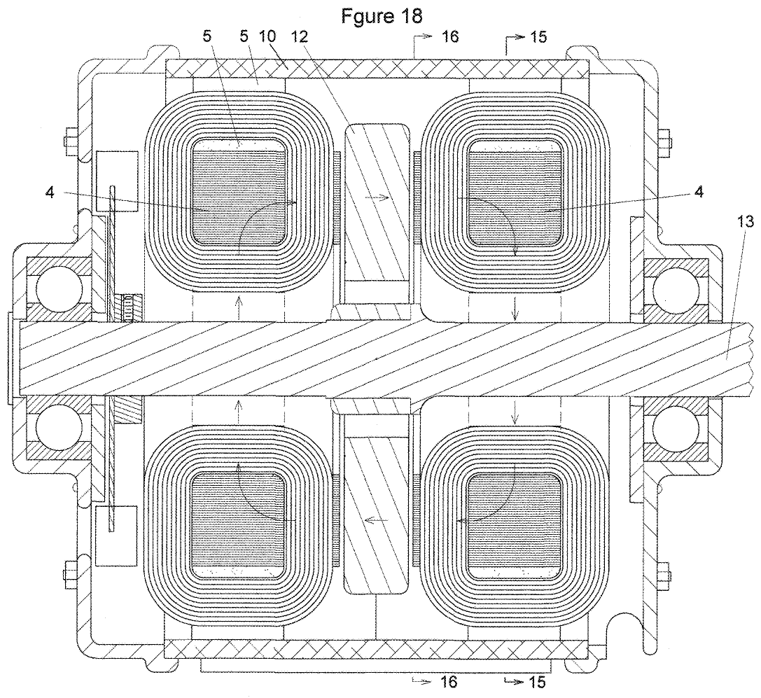

FIG. 15 shows the cross-section 15-15, of the fully assembled FIG. 18 machine. FIG. 16 shows the cross-section 16-16, FIGS. 18 & 20 of only the stator in FIG. 16. FIGS. 17A & B shows only the insulated sleeve 5. For clarity, slot insulation is not shown. Referring to FIG. 15, an insulated sleeve 5, FIGS. 15 and 16, is placed over the rolled strip core 4, and firmly anchored to the rolled strip core with the screws 6, or any other suitable method. The insulated sleeve 5 has slots provided in the sleeve to accept the magnet wire of the coil 7. The insulated sleeve also has cooling air passages 8 provided within the sleeve. The sleeve itself can be made of any high temperature insulating material such as glass or ceramic material. Insulating barriers 9, FIG. 16 are provided near the inside of the rolled strip core in order to keep the coils separated. The fully assembled stator of FIG. 16 is then placed in the stator sleeve 10 of FIG. 15, then firmly anchored in place by the screws 11, or other suitable method. The insulated sleeve 5, FIGS. 17A and 17B have rounded corners where magnet wire wraps over them.

FIG. 18 shows an axial cross-sectional (axial cutaway) view of a brushless twin stator rolled laminating steel strip core motor or generator. In this particular view, a solid iron or steel rotor 12, is pressed (or keyed) onto the shaft 13. This iron or steel rotor is opposed by two rolled strip cores 4. Each of these two rolled strip cores which contain their windings is a stator assembly.

Hereafter this complete stator assembly will also be referred to as a “stator”.

Assuming FIG. 18 is a 2 pole motor, and the arrows indicate the magnetic path; starting at the top left, the magnetic field of the left stator passes through the iron or steel rotor 12, and joins the magnetic field of the right stator, then goes downward both behind the shaft and in front of the shaft, then join together, turn and pass through the bottom of the iron rotor, then joins the magnetic field of the left stator into the lower part of the left stator, then turns and heads upwards both behind the shaft and in front of the shaft, after which they join together again at the top left. In order to accomplish this, both stators must be properly connected so that they both rotate in the same direction, with magnetic poles properly aligned to create the magnetic field shown by the arrows in FIG. 18.

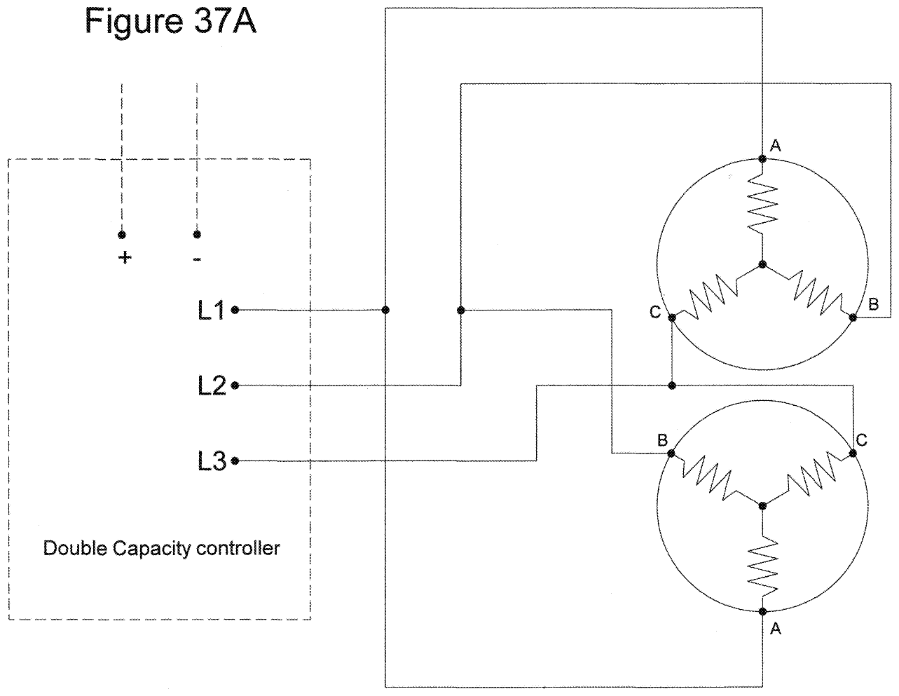

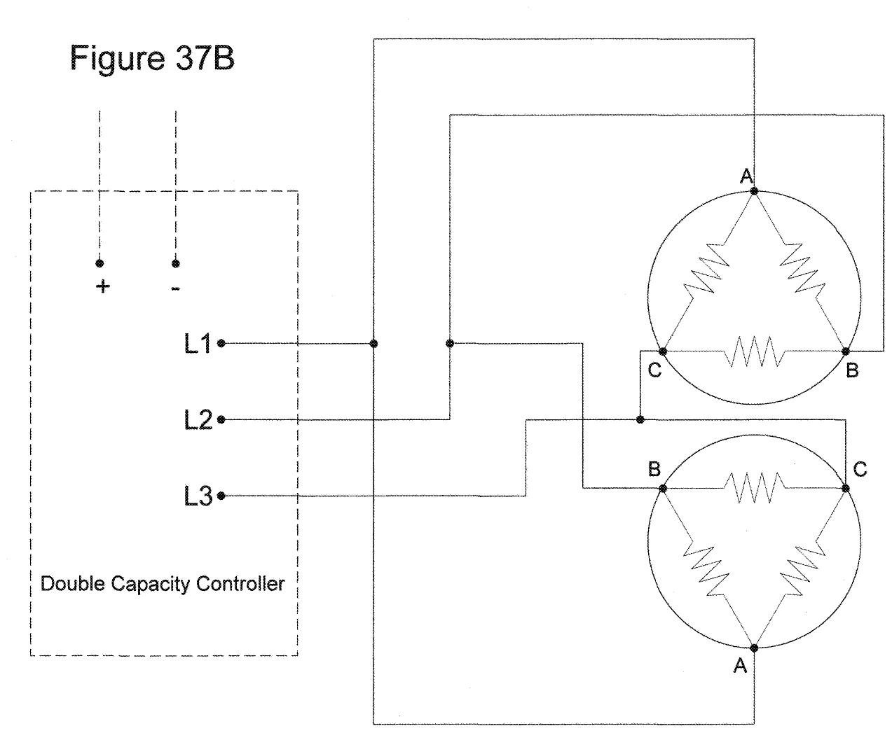

FIGS. 37A (star connected) and 37B (delta connected) stators show how the windings (or stators) must be positioned to properly align both stators. The upper rear stator drawing (or it's connections) must be rotated 180 electrical degrees from the lower front stator drawing. The same 180 electrical degree relationship occurs between 9A and 9B.

Unlike the twin rotor version, the brushless twin stator doubly fed rolled steel strip electric machine is designed to have one common shared rotating magnetic field, which forces the magnetic field to travel crosswise (axially) through the rotor, thereby dramatically reducing the magnetic field distortion (armature reaction equivalent) when fully loaded. This prevents most of the magnetizing current increase which normally occurs when a conventional poly phase motor's field is distorted due to a full load. This field distortion reduction therefore improves power factor, efficiency, and torque output.

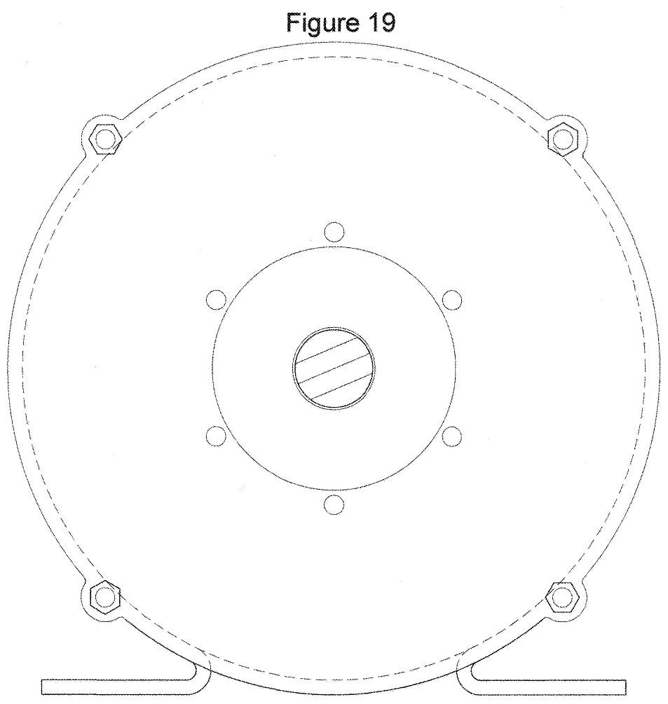

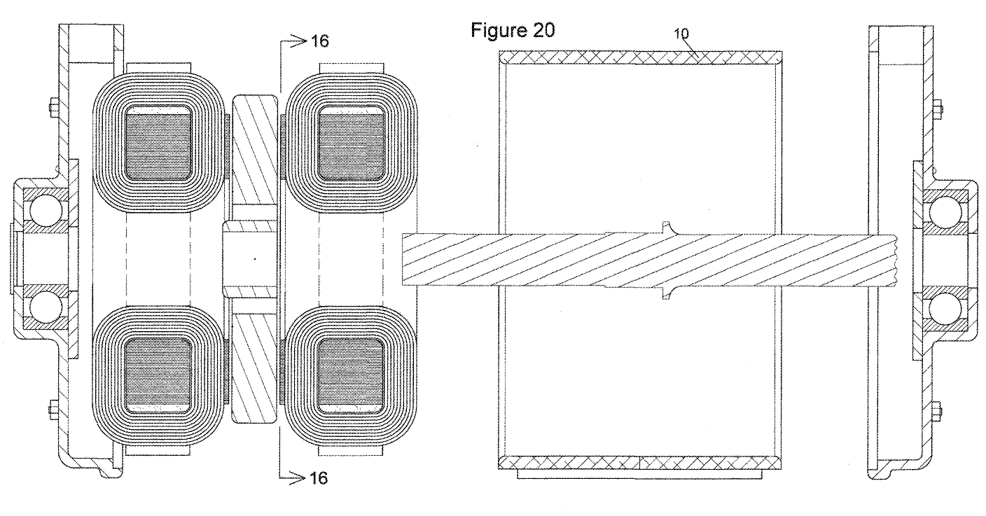

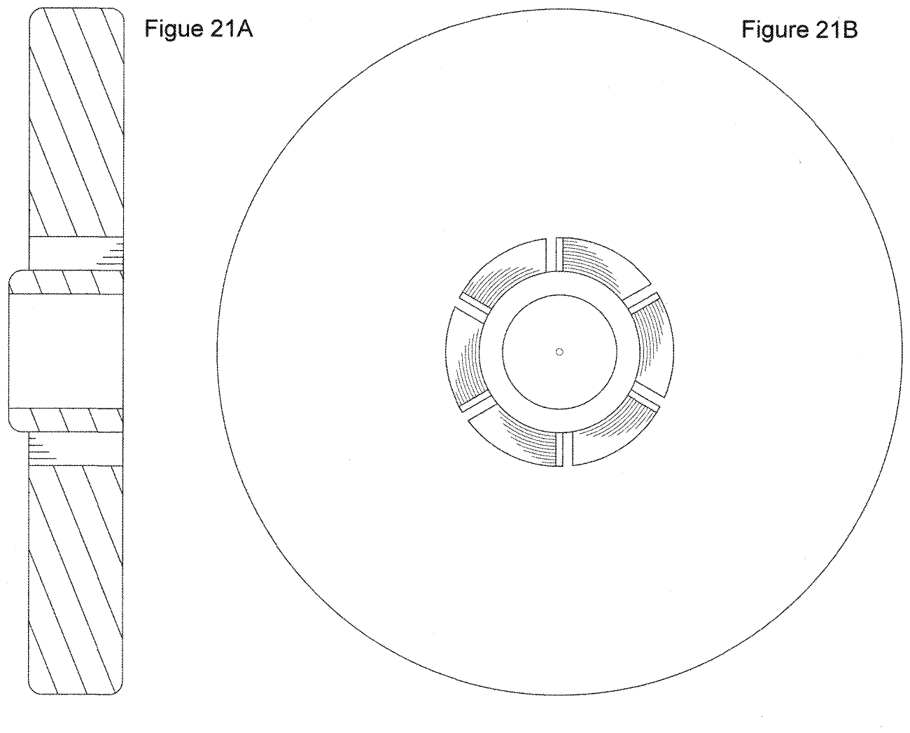

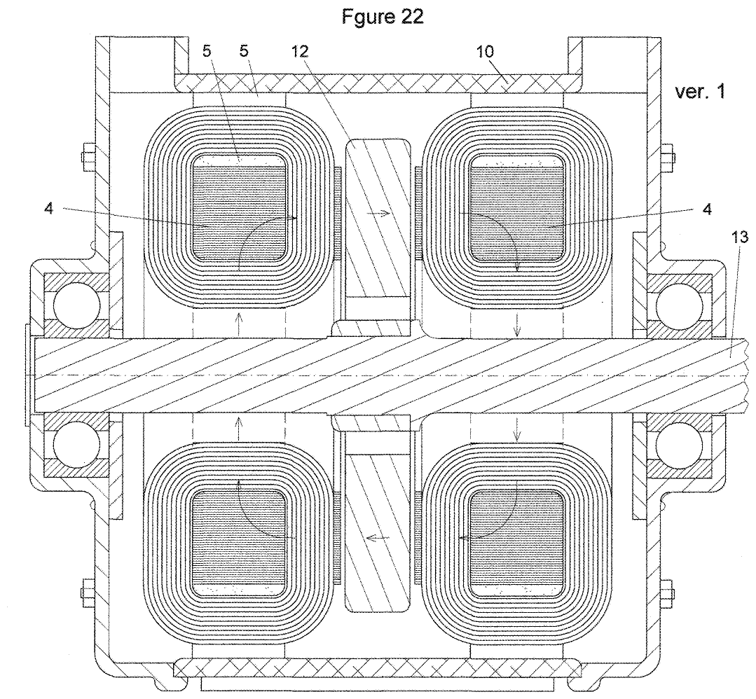

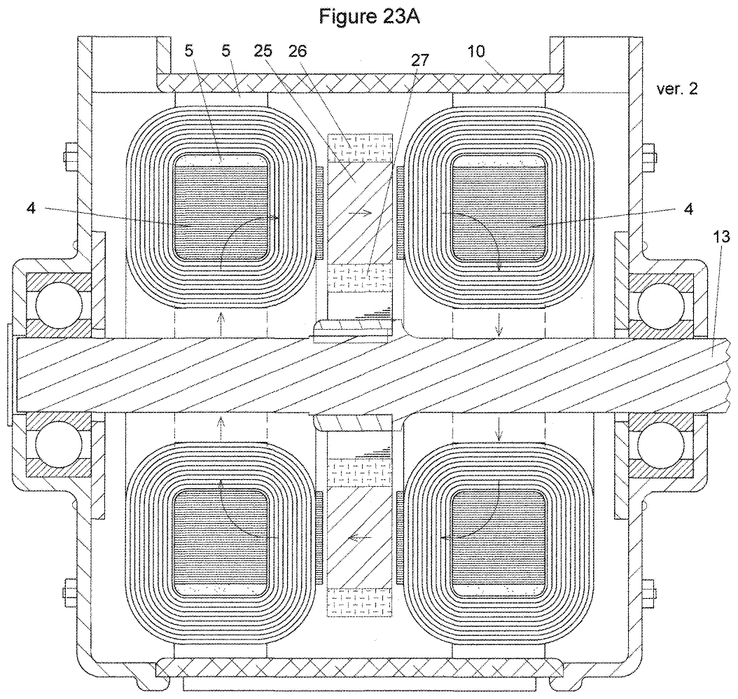

FIG. 19 is an end view of FIG. 18. FIG. 20 is an exploded view of FIG. 18.

Iron or steel rotors, such as in FIGS. 21A and 21B, need to be supplied power from a variable frequency controller capable of bringing a motor from standstill up to full load. When properly designed, the iron or steel rotor can modulate the current pulses powering the motor.

FIG. 22 is identical to FIG. 18 except for the cooling method. FIG. 18 is self cooled (internal fan) while FIG. 22 needs to be supplied with a continuous supply of cooling air to its cooling air ports, (top of machine). FIG. 22 is designed for continuous operation even at very low speed, such as in FIGS. 22 through 27, while FIG. 18 is designed for a minimum fixed speed such as in FIGS. 9 through 13.

FIG. 22 is the main view for the six rotor versions of this main view. All six rotor versions share the same type of stators.

### Version 1:

The solid iron or steel rotor 12 used in FIGS. 18, 20, 21A, 21B, and 22 is a much poorer conductor of electricity than the aluminum or copper normally used to conduct the current induced in a conventional induction motor. For this reason, extra iron or steel had been added to the outside and also to the inside of the rotor of FIG. 18 in order to help carry these induced currents created in the rotor, yet it usually is not enough for a 2 pole motor.

### Version 2:

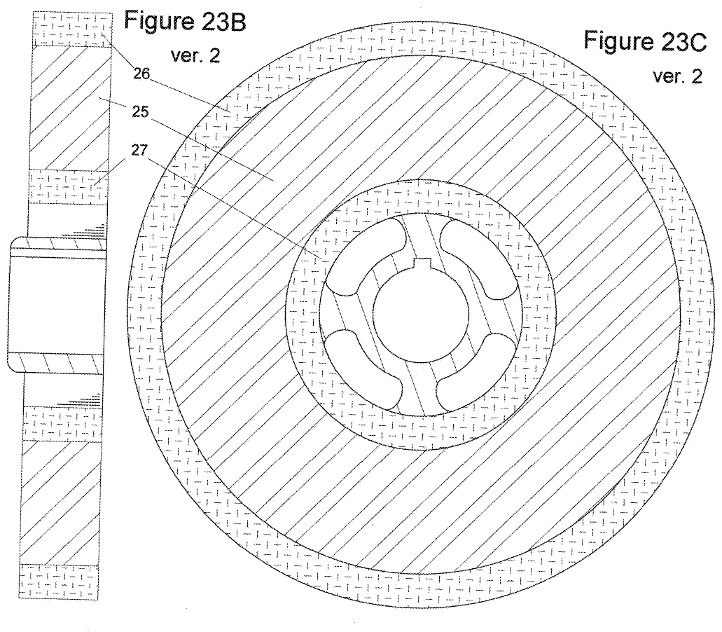

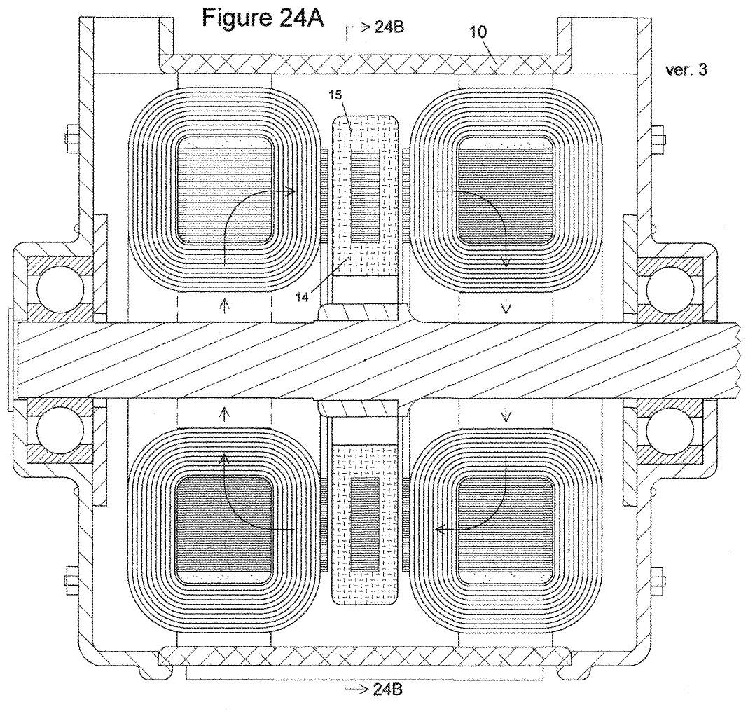

FIG. 23A, 23B, and FIG. 23C demonstrate how a slot free iron or steel rotor of FIGS. 18, 20, 21A or 22 can be redesigned to improve its performance.

The solid iron or steel rotor of FIG. 18 and FIG. 22 is a much poorer conductor of electricity than the copper or aluminum normally used to conduct the current induced in a conventional induction motor. For this reason, extra iron or steel had previously been added to the outside and also to the inside of the rotor of FIG. 18 and FIG. 22 in order to help carry these induced currents between the magnetic poles induced in the rotor.

Because of its much higher resistance, the extra iron or steel necessary to lower the resistance for two pole, and even some four pole rotors are excessive, due to their much greater outer and inner diametrical size requirement. FIGS. 23A, 23B, and 23C show how most of this problem can be addressed. The rotors shown in FIGS. 23A, 23B, and 23C have two copper rings bonded to the inside and to the outside of the iron or steel rotor core.

The iron or steel rotor core of FIGS. 23A, 23B and 23C has both its outside diameter and it's inside diameter altered to accommodate only the magnetic field passing crosswise through the core. In FIGS. 23A, 23B and 23C, this altered iron or steel core is numbered 25. The outside copper current carrying ring is numbered 26 and the inside current carrying ring is numbered 27.

One way to electrically bond the copper rings to the iron or steel core is by 1. Copper plating both the outside and the inside curved steel surfaces of the rotor which mate with the copper rings. 2. Heat the rotor parts and both copper rings. 3. Wet the mating surfaces with a bonding metal containing a significant quantity of silver, which lowers the electrical resistance of the bonding metal. 4. Reheat the copper rings and the iron or steel rotor parts, and assemble them together as shown in the drawings, adding extra bonding metal if necessary. 5. The bonded assembly is then allowed to cool. 6. The completed rotor assembly is then tested to ensure complete continuity.

A second way to electrically bond the copper rings to the iron or steel core is by 1. Copper plate both the outside and inside curved steel surfaces of the rotor which mate with the copper rings. 2. If necessary, preheat these copper plated parts. 3. Using melted copper and the same technology used to create the squirrel cages of electric motor squirrel cage rotors, create the copper rings in their proper locations between their mating copper plated steel parts. 4. The completed rotor assembly is then tested to insure complete continuity.

This bonded assembly, as shown in FIG. 23A, 23B, and FIG. 23C, is superior to the rotor shown in FIGS. 18 and 22, because the electrical current traveling between the induced magnetic poles can find a lower resistance path through the copper rings, thereby increasing performance due to the increased electrical current flowing through the copper rings.

### Version 3:

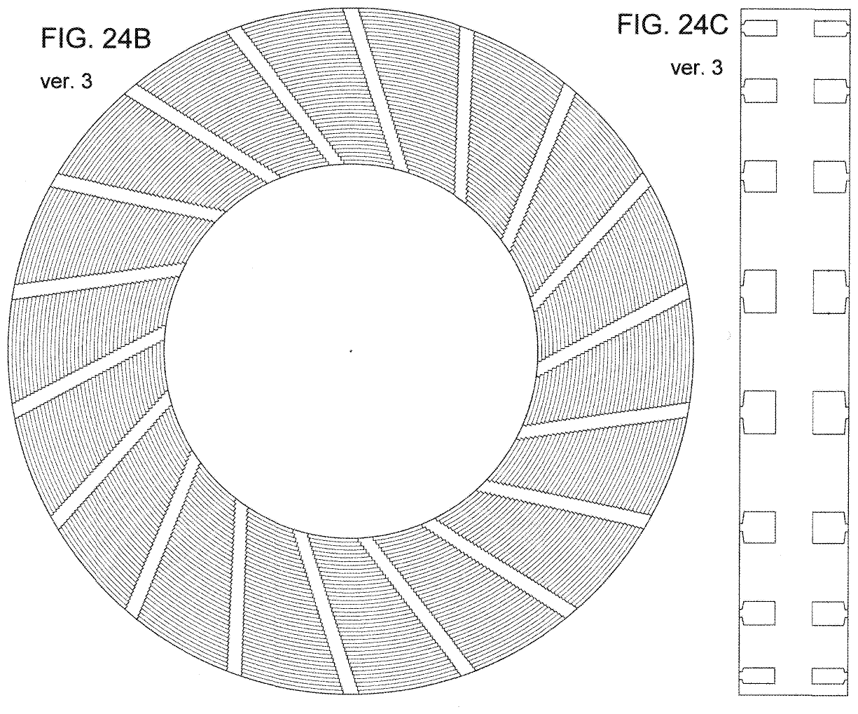

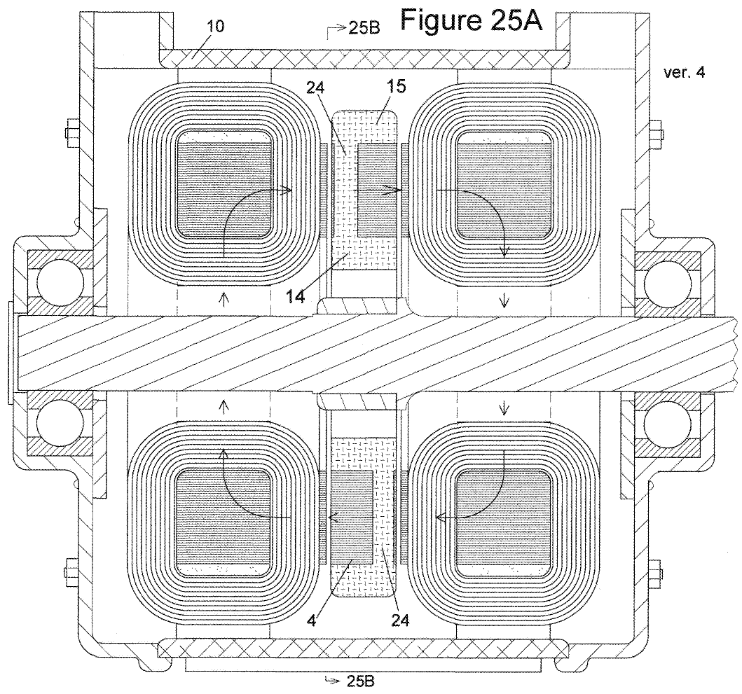

FIG. 24A is identical to FIG. 22 with the exception that the rotor has been redesigned. The iron or steel rotor of FIG. 22 has been replaced by conventional simulated squirrel cage rotor redesigned to be used with a rolled strip core. This rolled strip core is shown in FIGS. 24B and 24C. FIGS. 24B and 24C shows a skewed rolled strip core ready for casting the simulated squirrel cage metal around it.

FIG. 24C is the right side view of the skewed rolled strip with the slots provided for two sets of skewed radial conductors, all of which radiate from one central ring hub collector 14, FIG. 24A, and are all joined together on the outer end by the simulated outer ring collector 15, FIG. 24A.

The rotor shown in FIG. 24A shows two conducting spokes at the top of the rotor and another two conducting spokes at the bottom of the rotor. The rotor shown in FIG. 24A shows a cross section of the finished simulated squirrel cage type of rotor. The magnetic path is configured in the same manner as that of FIG. 22. The arrows shown in FIG. 24A indicate this magnetic path.

Referring to FIG. 24A, the amount of skewing shown in the drawing is less than a full skew. A full screw would provide the best electrical performance, however the amount of skewing necessary to accomplish this is often impractical, because a full skew would require the bottom of one skew to be radial alignment with the top of the next skew.

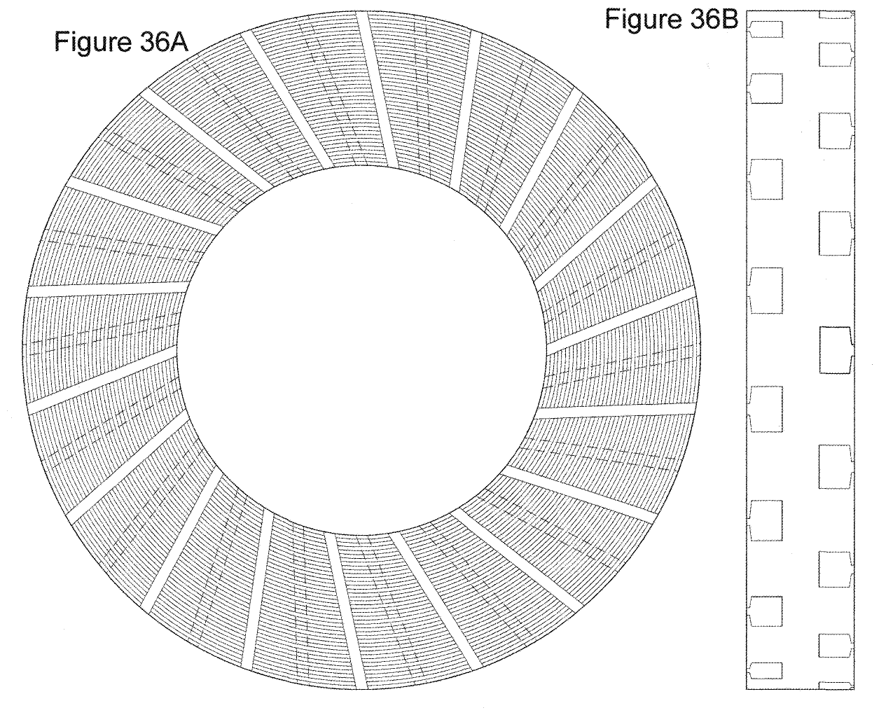

Since the rotor in FIG. 24A has two sets of windings, the second set of windings can be shifted from the first set by one half of the distance between the slots. This shifting of the slots is shown in FIG. 36. The solid skewed radial lines in the left view of FIG. 36 represent the front slots, while the rear slots are represented by the dashed lines. The right view of FIG. 36 shows how the slots can be staggered. Such staggered slots allow the rotor to provide the best electrical performance while skewing the slots only one half of the distance required in the paragraph above. Therefore, by creating a half skewed group of slots on both faces of the rotor, and staggering them from each other midway between the slots, the equivalent of the desired full skewed rotor is created.

### Version 4:

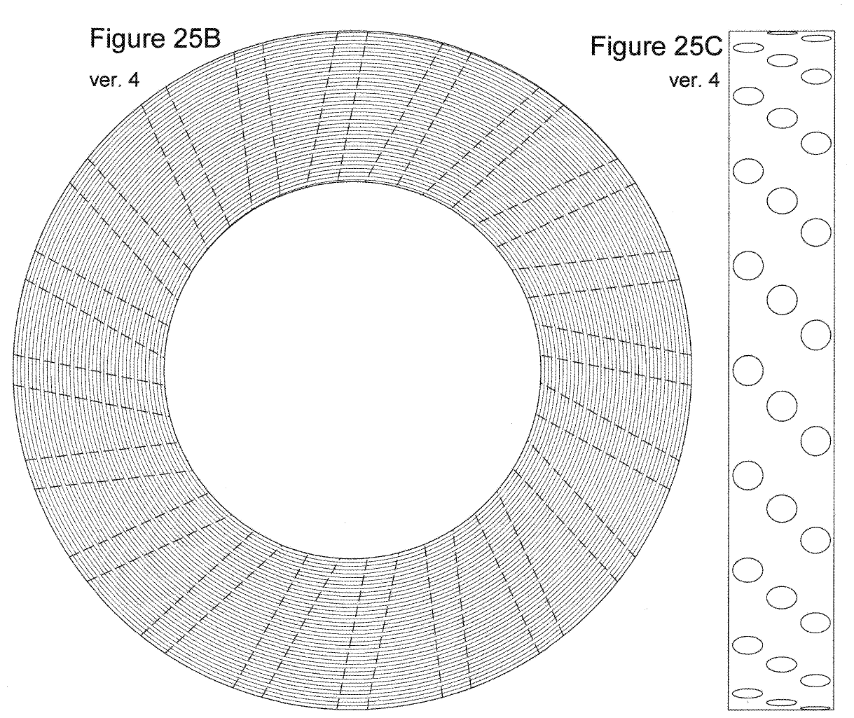

FIG. 25A is identical to FIG. 22 with the exception that the rotor has been redesigned. The iron or steel rotor, FIG. 22, has been replaced by a unique type of rotor design. This type of rotor design calls for 3 sets of radial conducting spokes 24, which radiate from a central ring hub collector 14, FIG. 25A, and all are joined together on the outer end by the simulated outer ring collector 15, FIG. 25A. This triple set of radial conducting spokes pass through the rotor's rolled strip core 4, FIG. 25A. Only the closest row of spokes are shown (dashed lines) FIG. 25B. The rotor shown in FIG. 25A shows a cross-section of one radial conducting spoke at the top of the drawing and another radial conducting spoke at the bottom of the drawing. The magnetic path is configured in the same manner as that of FIG. 22. The arrows shown in FIG. 25A indicate this path.

There is an advantage of the rotor design in FIG. 25A over the rotor design in FIG. 24A. Studying the rotor design in FIG. 24B reveals that the amount of laminated steel on the rotor side of the air gap is reduced by the total area occupied by the narrow portion of the rotor slots. The length and width of each slot multiplied by the number of slots represent the loss of the total area of the laminated steel at the air gap that might have been eliminated.

Although narrow slots on the stator side of the air gap are necessary for insertion of the magnet wire, they are not absolutely necessary in the rotor, since the rotor conductors can be cast in place using molten metal with modern techniques for driving this molten metal into difficult to fill voids. The laminated steel rotor of FIGS. 25A ,25B, and 25C does not contain slots, therefore the entire area facing the stator is made of laminated steel, thereby maximizing the magnetic field available at the air gap.

Another way to manufacture the rotors of FIGS. 25A 25B, and 25C is to assemble a blank rotor core with it's inner and outer rings, then drill holes through the assembly for full length conducting spokes (rods); insert these conducting rods, then weld these rods to the inner and outer rings.

### Version 5:

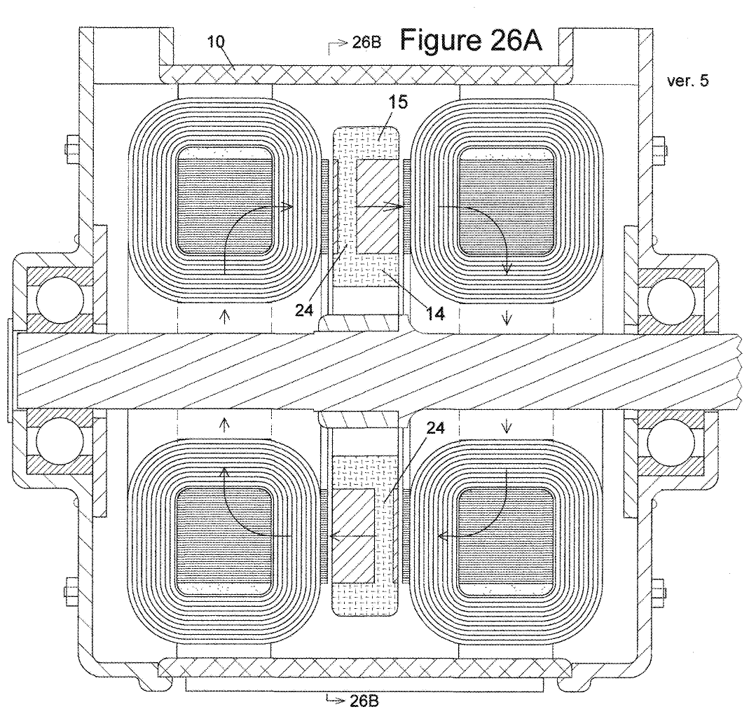

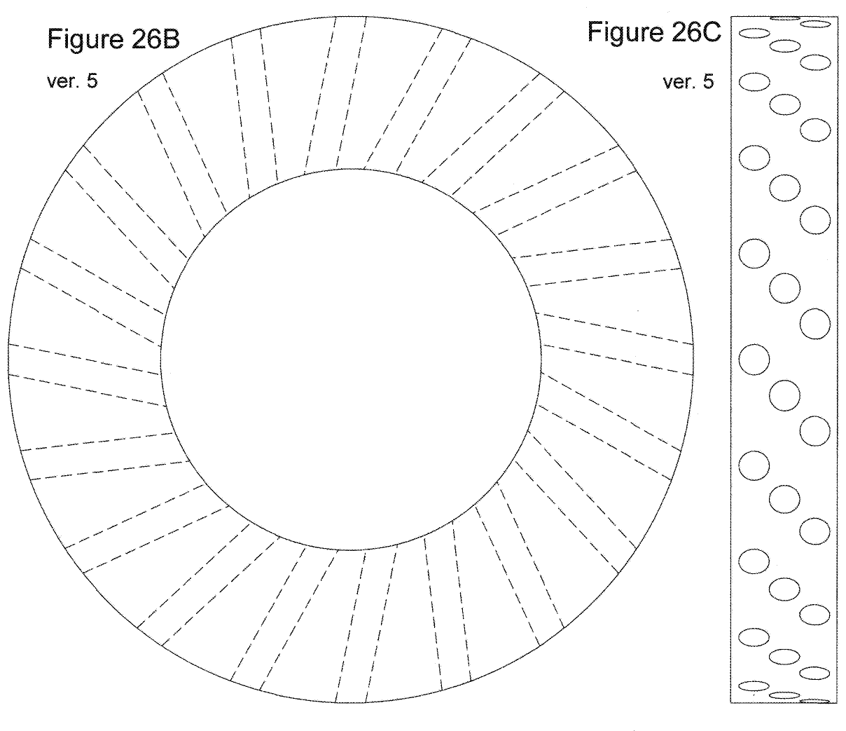

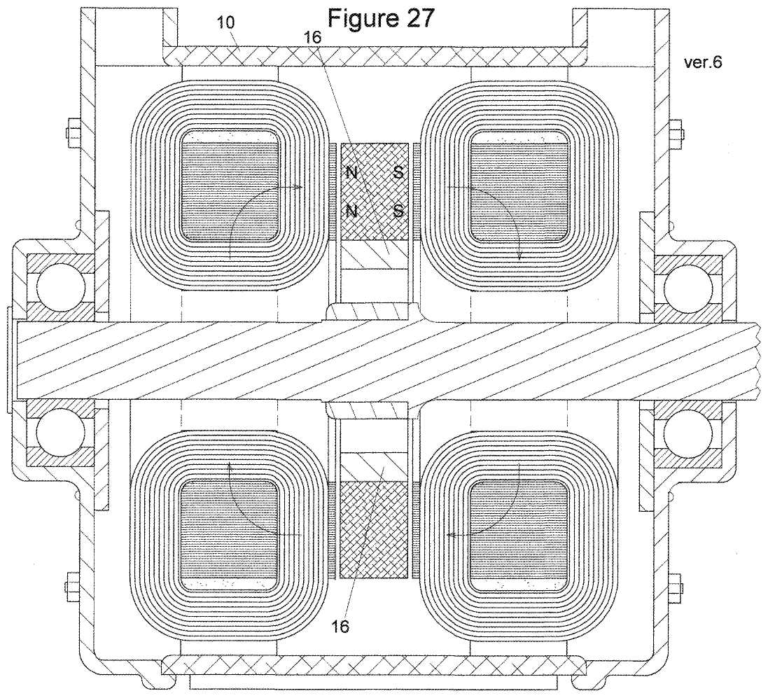

In FIGS. 26A, 26B and 26C, the laminated steel core of the rotor is replaced by an iron or steel core. This solid core type of motor will probably require a variable frequency controller which, when used, would likely provide good performance.

### Version 6:

FIG. 27 shows a motor or generator where the rotor contains either individual permanent magnets, or one single permanent magnet ring, pre-magnetized with the necessary number of poles. A non magnetic sleeve 16 is added to prevent a magnetic short circuit of the magnet. The magnets or the ring are firmly attached to the outside of the nonmagnetic sleeve and the shaft hub with it's spokes are firmly attached to the inside of the non magnetic ring using conventional means. This machine is defined as a synchronous motor or generator. The performance of this synchronous machine should be similar to a conventional synchronous machine.

### Two Rotors and One Stator Verses Two Stators and One Rotor

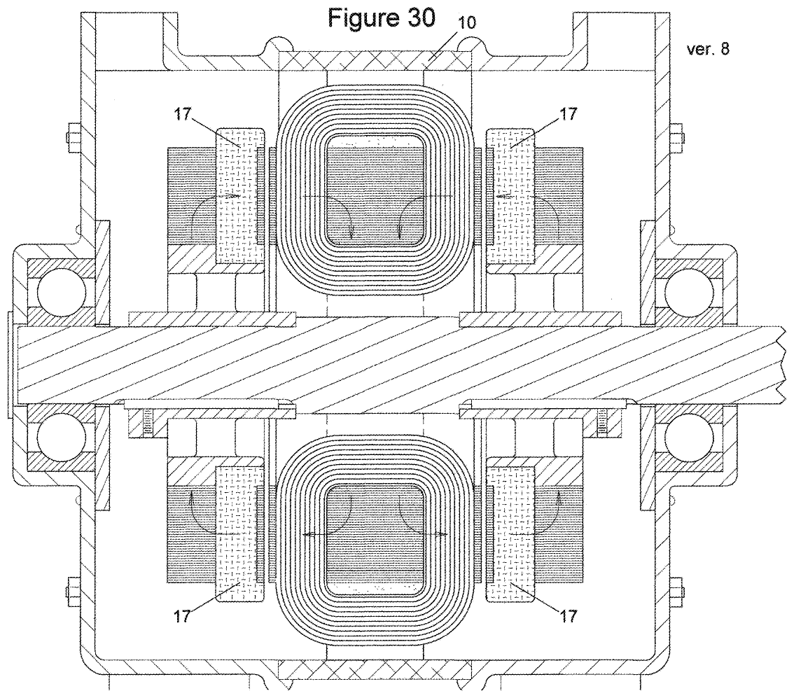

Figures of 29 through 33 show a motor or generator where a single stator is surrounded by two rotors. This single stator has two active faces which share a single winding as shown in the drawings. The performance of this type of motor or generator should be similar to the machines described previously, since they also use rolled strip cores and similar windings, with the following two exceptions: The 2 magnetic fields are not shared, and in FIGS. 29 and 30 the magnetic (armature) reaction is elongated more, each of which requires additional magnetizing current.

The stator core design used for figures of 29, 30 and 31 is shown in the figures of 32. FIG. 29 uses two iron rotors with only one active face each, compared to FIG. 22, which uses only one iron rotor with two active faces. Since a single stator coil is wound into a slot on one side of the stator, and also into another slot on the other side, a significant amount amount of wire is saved.

### Version 7:

FIG. 29 is a variation of the FIGS. 23A to C. Like in the figures of 23A to C, the rotors consist of iron or steel cores which are contained within inner and outer copper rings. The iron or steel cores are electrically bonded to the copper rings in the same way as in FIGS. 23A to C.

In FIG. 29, empty narrow radial slots 16a are cut half way into the face side of the rotor core between the inner and outer rings. These slots force the rotating magnetic field to expand beyond the slots and into the more permeable unslotted iron or steel area, 16b. This expansion of the magnetic field causes this field to cut the iron or steel core between the empty slots, which induces the desired torque producing current between the empty slots. The number of radial slots necessary would be no more the stator coil slots.

### Version 8:

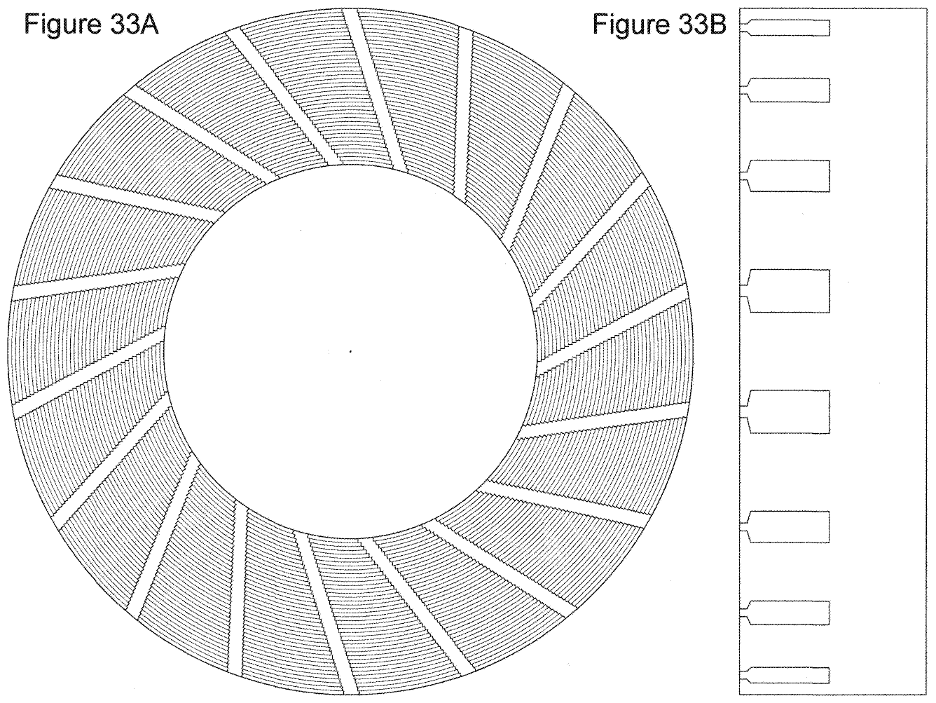

FIGS. 33A and 33B shows a rolled strip rotor core, which is used in FIG. 30. The side view, FIG. 33B, shows the slots cut into the rotor's rolled strip core, which are filled with melted metal, in order to create a rotor similar to a conventional squirrel cage rotor. Like other rotors, these rotor's laminations are skewed to improve performance. The slots in FIG. 33B are only on one side as shown in the right side view because these rotors have only one active side. The drawing shown in FIG. 30 shows the simulated squirrel cage 17, embedded in it's rolled strip core.

### Version 9:

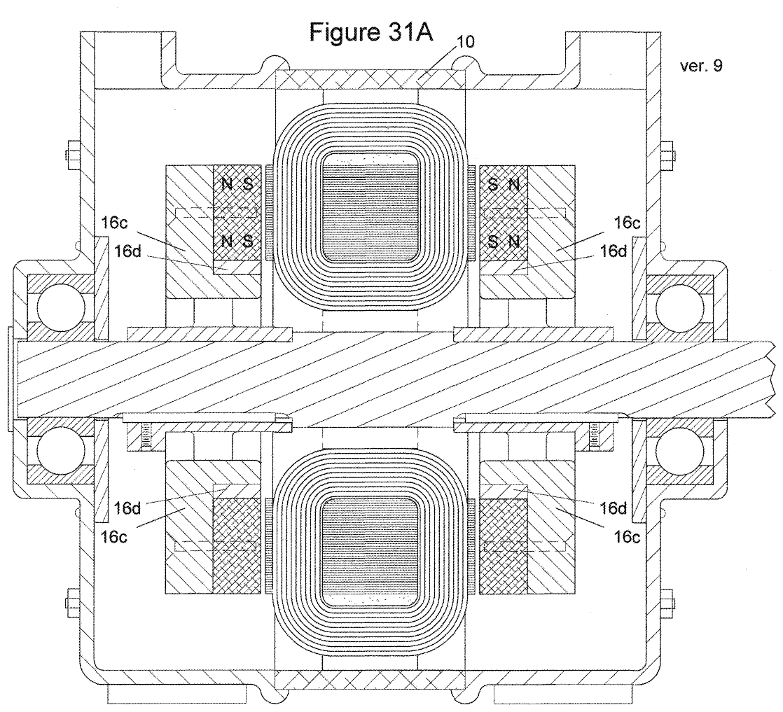

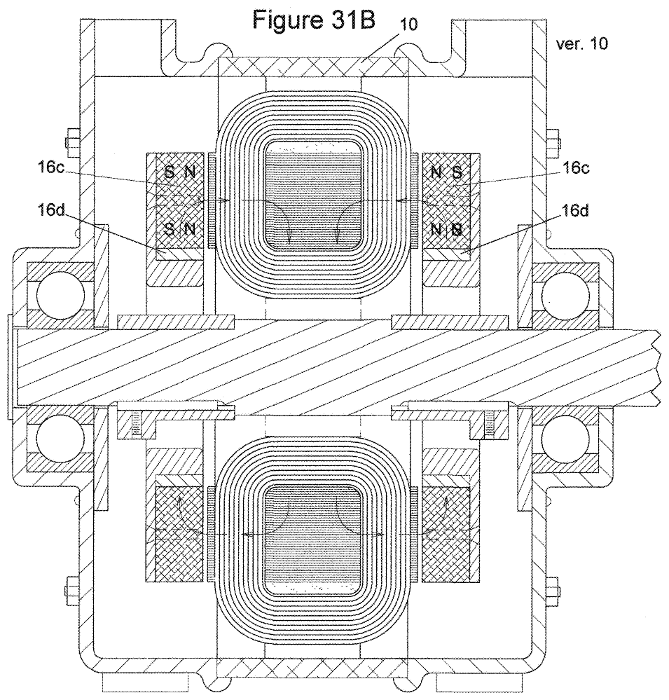

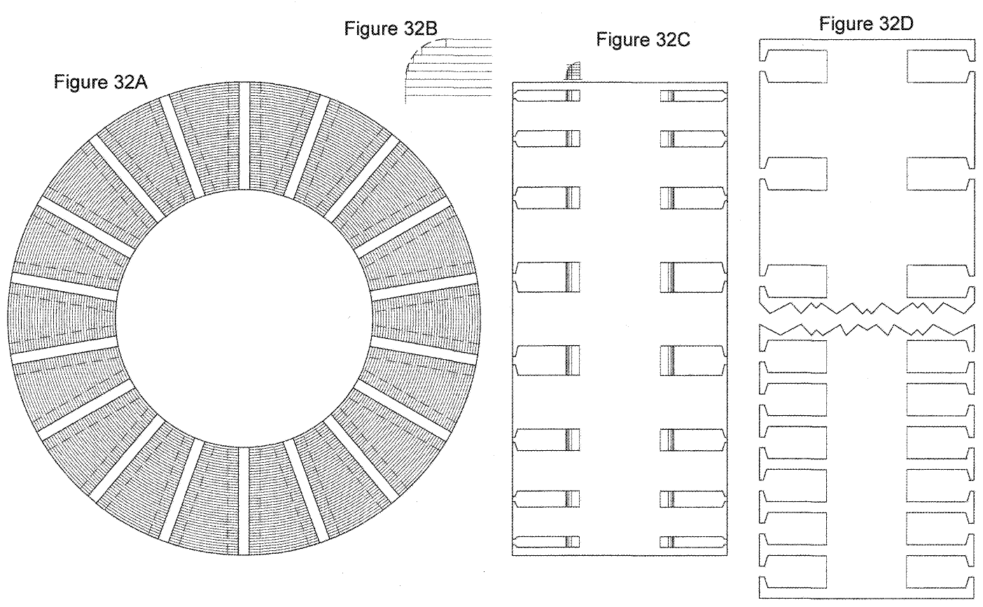

FIG. 31A shows the use of individual permanent magnets which are attached to an iron or steel core, 16c, in order to complete the rotor portion of the magnetic circuit. Two non-magnetic metal sleeves 16d are installed as shown to prevent a magnetic short circuit in that area.

### Version 10:

The iron or steel core 16 of FIG. 31A is reduced in FIG. 31B because the permanent magnet is a one piece disk magnet which carries all of the moving magnetic circuit. In this version, the steel flange 16c serves only to support the disk magnet. Like version 9, two non-magnetic metal sleeves 16d are installed as shown to prevent a magnetic short circuit in that area.

### More About Rounded Corners

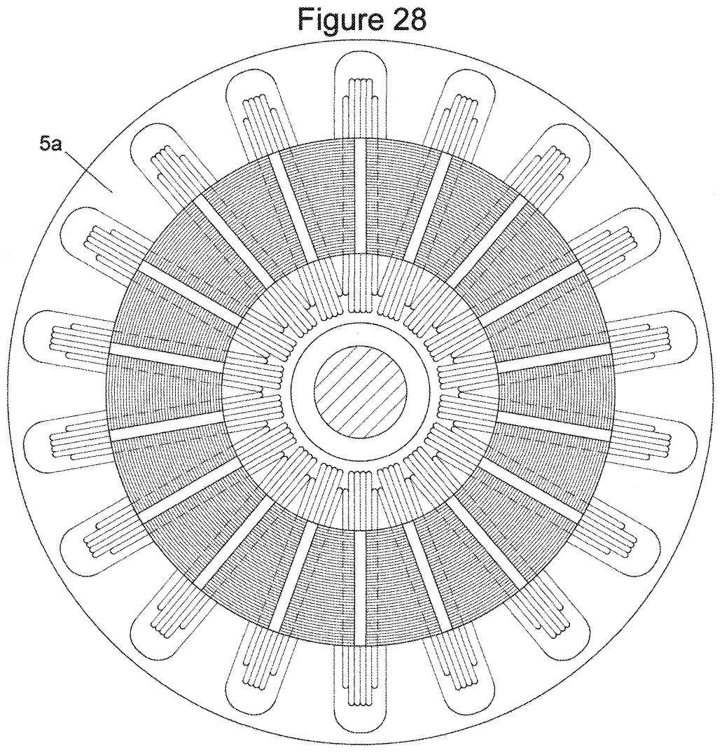

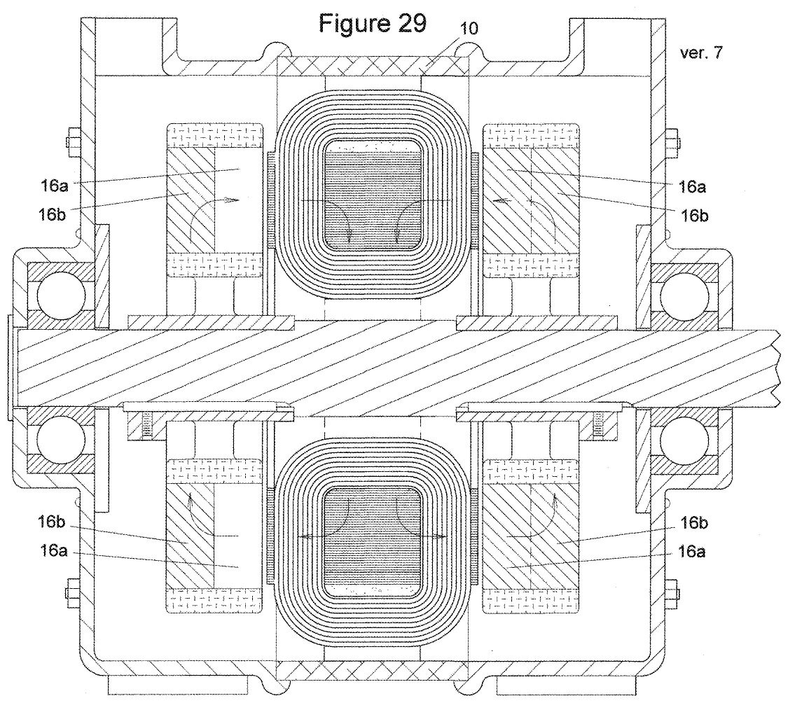

In the previous drawings, only the inside corners of the rolled strip core were rounded. The outside corners were left unchanged because the insulating sleeve which was attached to the outside of the rolled strip core did have rounded corners where the magnet wires passed over them. FIGS. 28, 34, and 35 show applications where all four corners are rounded.

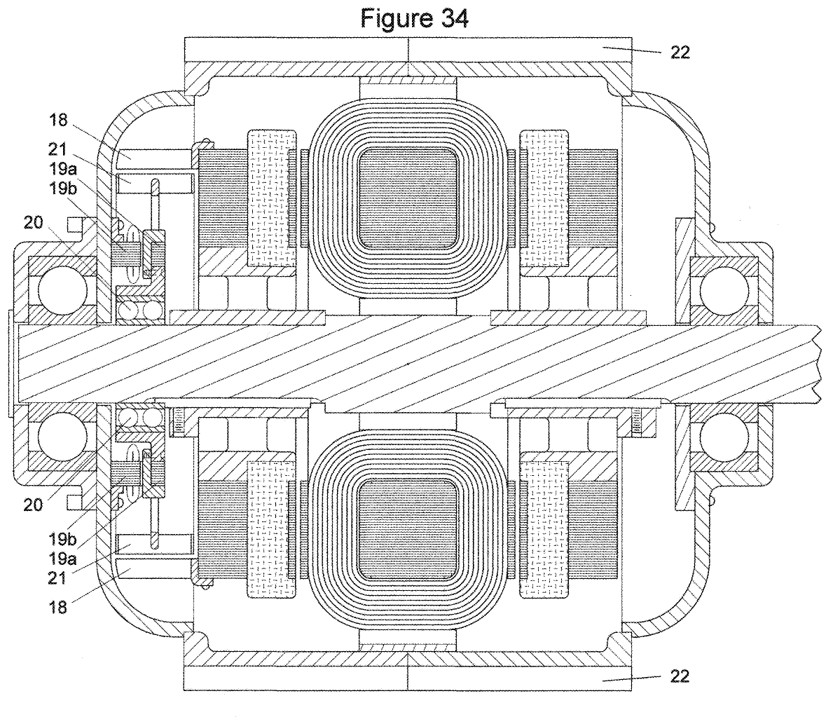

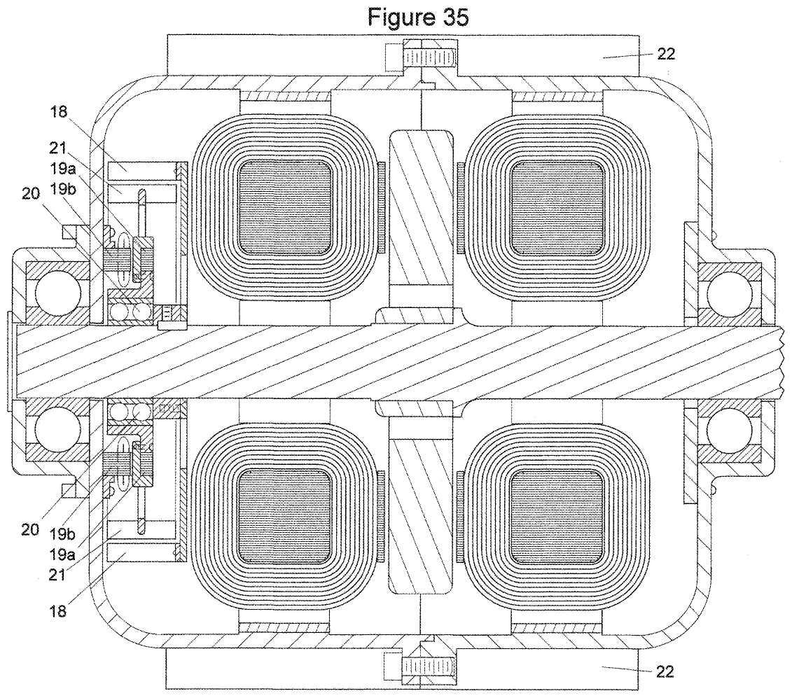

In the figures of 32A to 32D; 32A shows a front (face) view of a rolled strip core, 32B shows an enlarged corner, 32C shows a right end view of 32A, and 32D shows the beginning of the strip in the lower drawing and the end of the strip in the upper drawing. FIGS. 33A, 33B and 28 shows how the magnet wires can be installed through the slots and around the rest of the rolled strip core. A different type of insulating sleeve 5a, FIG. 28, is installed over the rolled strip core and securely fastened to it AFTER the windings are installed. FIG. 34 shows a single stator whose core is rounded in all four corners and surrounded by two rotors. FIG. 35 shows a single rotor surrounded by two stators whose cores are rounded in all four corners.

### Preventing Induced Current in the Stator Housing, 10

A cylindrical insulated stator housing, 10, made of insulating material such as fiberglass, is used instead of metal to prevent induced currents from being generated by the stator coils into the stator housing.

### Cooling Brushless Double Fed Rolled Steel Strip Electric Machines

FIGS. 34 and 35 also show an improvement to the cooling system of totally enclosed motors. A conventional fan or blower 18, FIG. 34 and FIG. 35; indirectly or directly attached to the shaft, is usually all that is necessary to keep the motor cool when operating at rated speed, even when under full load. A small supplementary built in blower motor rotor 19a, with it's attached blower cage, 21, FIGS. 34 and 35, could be provided to increase cooling air flow during periods of overload, or while operating for an extended periods at lower than rated speed. This supplementary blower motor (19a and 19b), FIGS. 34 and 35, is also of the rolled strip core design. In this case, the stator core 19b is attached to the end bell and the rotor 19a is supported by it's own bearings, 20, which could be fitted to the shaft, as shown in the drawings. This blower motor is neither of the double stator or double rotor design, but a single rotor/stator design.

FIGS. 34 and 35 shows cooling fins 22 attached to and radiating from the outside of the motor. These cooling fins could radiate the heat of the motor into the atmosphere, provided there is a sufficient air stream passing across these fins. In a motor vehicle, an additional wheel motor blower could be attached to the vehicle body close to the vehicle motor, and the discharge port of this blower connected to one or more nozzles which blow cooling air over the fins 22 of FIGS. 34 and 35.

### Alternative Cooling Solution:

Cooling ports are provided at the top of the drawings in figures of 17 to 25, 27, and 29 to 31. These ports are designed to accept ductwork which would be connected to a cooling air supply blower. In a motor vehicle, both the wheel motor and the supply blower could be anchored to the wheel backing plate, preferably near the top of the backing plate, where the ductwork would be short and both items would be protected better.

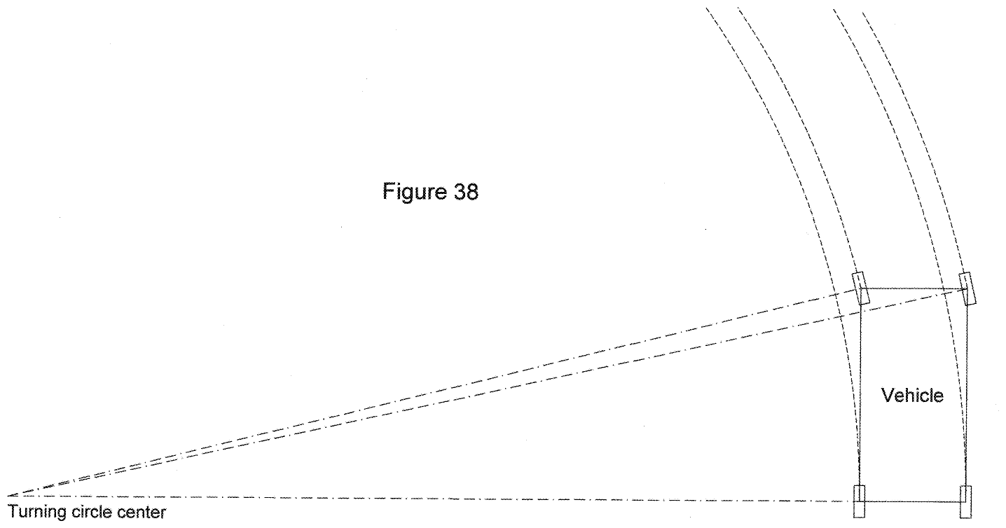

FIG. 38 shows why four individual double capacity controllers are necessary for 4 wheel drive motor vehicles. The tracks (dashed curved lines) rotated about the turning circle center, and since their radii are of different lengths, the speed of each wheel is different from each other. The speed differences require four separate controllers, one controller for each wheel.

### Steering Control Using A Frequency Shift Processor FIG. 38

Conventional vehicles with three or more wheels usually have at least one differential which is designed to transmit power at different speeds while turning a corner. This difference is necessary because wheels closer to the turning circle travel a shorter distance than wheels further out, therefore wheels further out must travel faster. The conventional differential solves this problem, however, but it also creates a problem with spinning of the wheel with the least traction (ice), and the spinning wheel absorbs almost all of the driving energy.

With steering control, the differential is eliminated. It is replaced by software which is designed to alter the speed of each individual wheel motor in order to provide the proper speed for each wheel motor whenever the steering wheel is being turned. The outboard wheel motor could be programmed to continue at the drivers selected speed during cornering, while the remaining wheel motor(s) would be reprogrammed to rotate proportionately slower according to their proportionate distances from the turning circle center.

A steering angle turn sensor, located where it can detect the angular deflection from the straight ahead position, sends this angular information to the frequency shift processor, which alters each wheel motor's variable frequency controller accordingly.

Because twin stator or twin rotor doubly fed electric machines have a speed mostly determined by their frequency, the speed of each wheel motor will remain largely unchanged when traction for a single wheel is lost, even on ice. Therefore, any remaining wheel motor with good traction can still move the vehicle.

### Braking Control Using the Frequency Shift Processor (no Figure)

The braking and regenerating assist control is very similar to the steering control. One difference being that this assist is provided when braking, regenerating, or both. Also the greatest speed decrease is applied to the wheel closest to the turning circle center. As in the steering control above, the outboard driving wheel could be programmed by the steering assist circuit to continue at the drivers selected braking or regenerating speed while cornering, while the remaining wheel(s) would be programmed to rotate proportionately slower according to their proportionate distance from the turning circle center. Braking and regenerating response is detected by the ABS speed sensor.

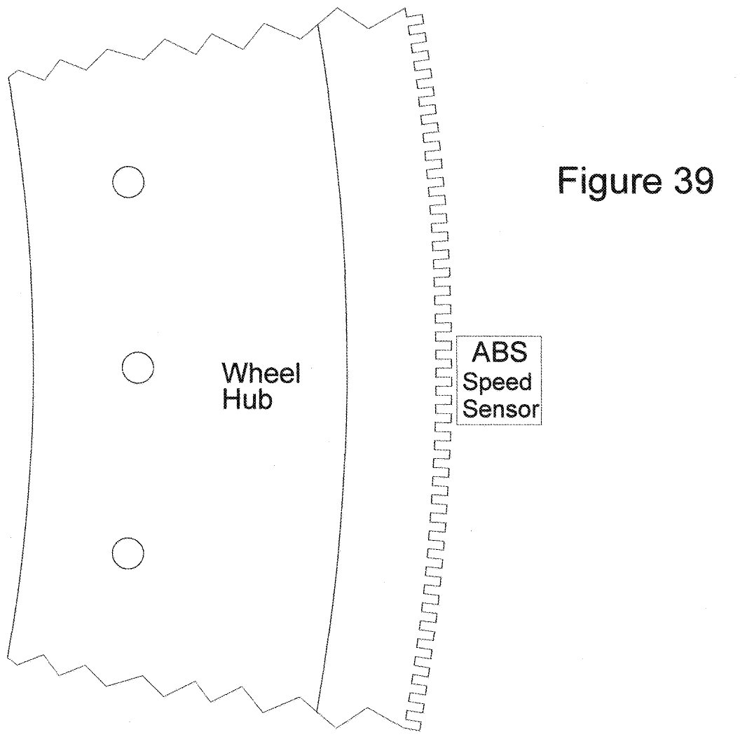

### Combined Braking System and Speed Sensor FIG. 39

FIG. 39 shows that the existing automatic braking system can be expanded to include a speed sensor for accelerating, regenerating and turning as well.

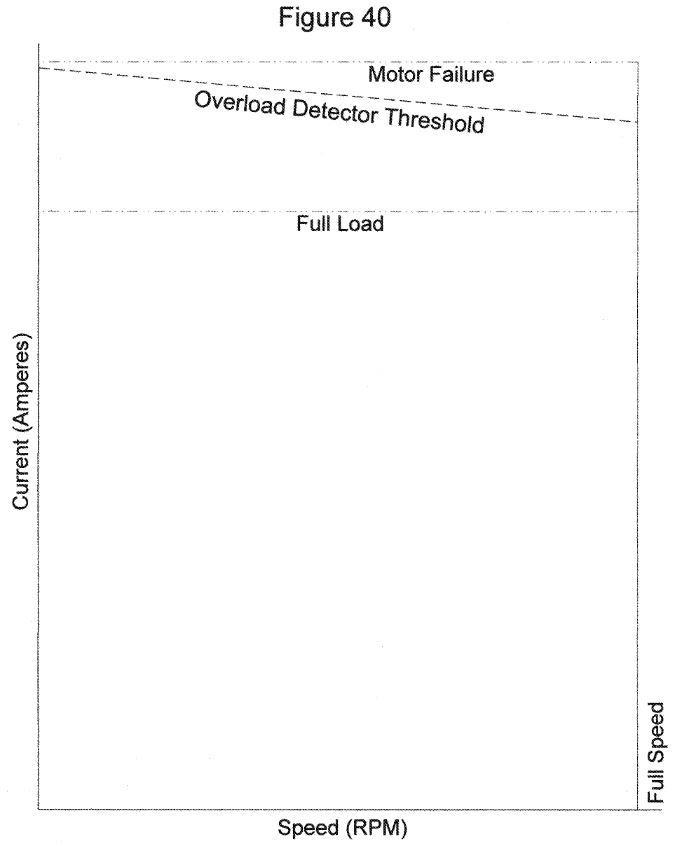

### Brushless Twin Stator Doubly Fed Rolled Steel Overload Solution FIG. 40

Conventional synchronous motors drop out of synchronous operation when they are overloaded, and unless protected against it, create serious current surges and eventually stall. The conventional solution to this overload problem is to use a current sensor that is set to activate at least low enough below the motor failure threshold in order to prevent the overload current from reaching this threshold. Tripping of this overload sensor activates the motor shut down circuit.

An improvement over the solution described above, and also for induction motors, is the use of software to decide the maximum safe threshold to which the current can rise without causing sudden disruptive motor shutdown.

This threshold is deliberately tilted so that its zero speed side is higher than its full speed side. This tilting is necessary in order to cause the controller to immediately lower the speed by lowering the frequency of the motor to a new lower frequency and speed which can handle the mechanical load of the motor without its current reaching the overload sensor threshold again. In other words, it accomplishes this by instantly dropping down to lower and lower speed until it finds a speed at which the current no longer is high enough to reach the overload detector threshold. This includes reducing the frequency, and thereby the speed, to zero, if the load is still too high. In order to accomplish this task the software will need input from a speed sensor as well as from a current sensor. Once the cause of the overload has been resolved, the double capacity controller returns the motor back to its selected speed.

### Brushless Doubly Fed Twin Stator Single Phase Radial Wound Electric Motor

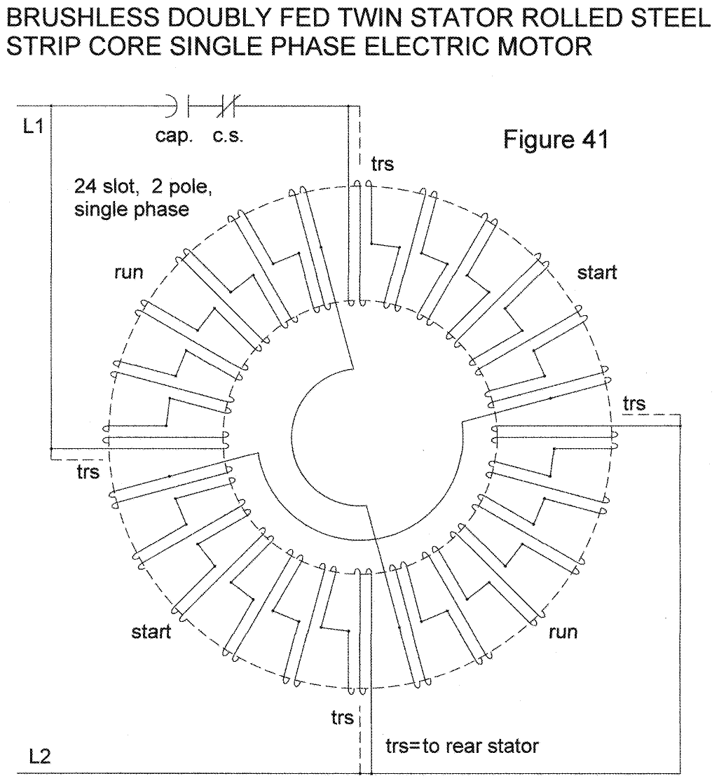

The circuit of the capacitor start motor is shown in FIG. 41. During the starting period, All the running (main) and starting (auxiliary) windings are connected across the line since the centrifugal switch is closed. The starting windings, however, are connected in series with the capacitor and the centrifugal switch.

The twin stators have their windings properly aligned with each other so as to create a common magnetic field. This common magnetic field passes crosswise through the rotor, this rotor being situated between the two stators.

When the motor reaches approximately 75% of full speed, the centrifugal switch opens. This action cuts out both the starting windings and the capacitor from the line circuit and leaves only the running windings across the line.

To produce a starting torque in a capacitor motor, a revolving magnetic field must be established inside the motor. This is accomplished by placing the starting windings 90 electrical degrees out of phase with the running windings. The capacitor is used to permit the current in the starting windings to reach its maximum value before the current in the running windings becomes maximized.

In other words the capacitor causes the current in the starting windings to lead the current in the running windings. This condition produces a revolving magnetic field in the stators, which in turn induces a torque producing current in the rotor windings. As a result, the common rotating magnetic field acts in such a manner as to produce rotation of the rotor.

This motor can be designed to provide the same characteristics, when compared to a conventional single phase capacitor start electric motor. The rotor itself can be designed to duplicate the performance of the rotor of a conventional single phase capacitor start electric motor.

### Brushless Doubly Fed Twin Rotor Single Phase Radial Wound Electric Motor

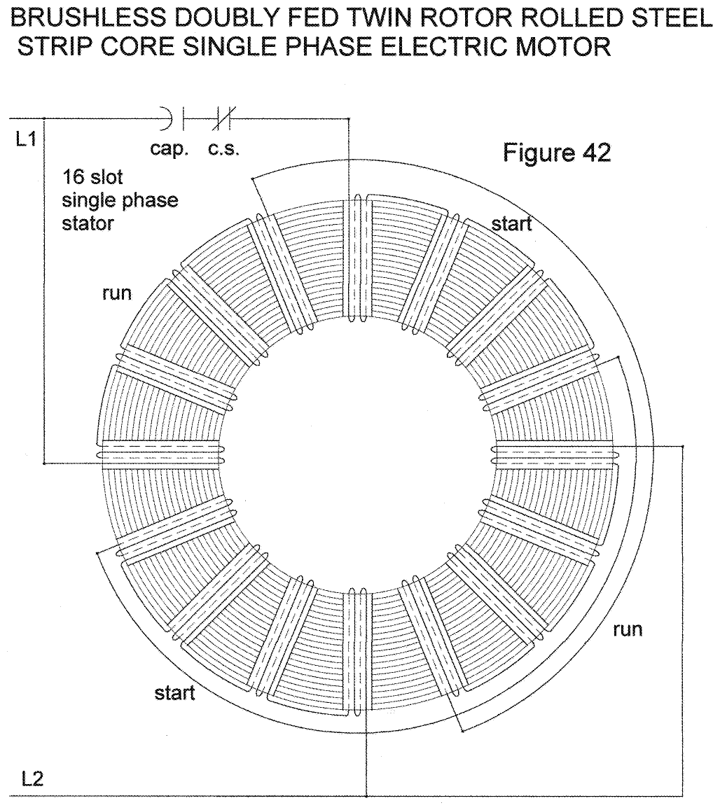

The circuit of the capacitor start motor is shown in FIG. 42. During the starting period, All the running (main) and starting (auxiliary) windings are connected across the line since the centrifugal switch is closed. The starting windings, however, are connected in series with the capacitor and the centrifugal switch.

When the motor reaches approximately 75% of full speed, the centrifugal switch opens. This action cuts out both the starting windings and the capacitor from the line circuit and leaves only the running windings across the line.

To produce a starting torque in a capacitor motor, a revolving magnetic field must be established inside the motor. This is accomplished by placing the starting windings 90 electrical degrees out of phase with the running windings. The capacitor is used to permit the current in the starting windings to reach its maximum value before the current in the running windings becomes maximized.

In other words the capacitor causes the current in the starting windings to lead the current in the running windings. This condition produces a revolving magnetic field in the rotors, which in turn induces a torque producing current in the rotor windings. As a result, the common rotating magnetic field acts in such a manner as to produce rotation of the rotor.

This motor can be designed to provide the same characteristics as a conventional single phase capacitor start electric motor. This is possible because this motor has one active stator with two active faces driving two active rotors, enabling the stator to deliver full power to the rotors. The rotors can be designed to duplicate the performance of the rotor of a conventional single phase capacitor start electric motor.

### Advantages of a Brushless Doubly Fed Radial Wound Electric Machine for General Use.

1. Each motor is almost half the size of a conventional electric motor because the stator windings can be back wrapped 2 pole, which can often be substituted for a 4 pole motor. The result is a half size, double speed motor of the same horsepower.

2. This brushless twin stator doubly fed rolled steel strip electric machine maintains all of the performance characteristics of a conventional multiphase motor or generator in spite of its reduced size and weight, therefore it usually makes an ideal substitute for a conventional multiphase motor or generator.

3. The rotor of the brushless twin stator doubly fed rolled steel strip electric generator or motor can be of the induction type (squirrel cage) or of the synchronous type (permanent magnet). Both types of generator or motor are free of brushes, therefore, slip rings and brushes maintenance issues which occur with many doubly fed wound rotor generators or motors are eliminated.

4. The brushless twin stator doubly fed rolled steel strip electric machine is designed to have one common shared rotating magnetic field, which forces the magnetic field to travel crosswise (axially) through the rotor, thereby dramatically reducing the magnetic field distortion (armature reaction equivalent) when fully loaded. This positive behavior prevents most of the magnetizing current increase which normally occurs when a conventional polyphase motor's field is distorted due to a full load. This field distortion reduction therefore improves power factor, efficiency, and torque output.

5. Combining a variable frequency controller with a multi speed connected stator (FIGS. 9-14) creates a more flexible controller since the overall speed can be controlled within defined speed ranges, thereby allowing better control over pulse width and amplitude modulation.

6. The combined magnetic fields that are created in the brushless twin stator doubly fed rolled steel strip machine requires only one half of the magnetizing current required for each individual stator, thereby improving efficiency, and power factor.

### Advantages of a Brushless Doubly Fed Radial Wound Electric Machine for a Vehicle.

The advantages listed in 1 through 6, above, referring to electric machines for general use also apply to brushless twin stator doubly fed rolled steel strip electric machines used for a vehicle. In addition, the following advantages are included:

1. Each motor is almost half the size of a conventional electric motor because the stator windings are back wrapped 2 pole, compared to the conventional 4 pole motor, thereby allowing placing most of the motor within the wheel rim space.

2. Almost ⅛ of the motor size of one single conventional 4 pole electric vehicle motor; when comparing one single conventional electric motor powering the vehicle, to four almost half sized wheel motors powering all four wheels.

3. By installing pinion gears on the motors and mating conventional or ring gears on the wheel hubs, no transmission or clutch is necessary. (Reversing is done electronically in the controllers) 4. Four variable frequency controllers with electronic steering control which, by feeding electrical power directly from the controllers to the wheel motors, eliminates the entire drive train which went from the engine to the wheels.

5. Four variable frequency controllers using full-time electronic stability control improves drivability.

6. Four variable frequency controllers can be optimized to provide both conventional electronic stability control along with regenerative braking in order to maximize energy recovery and provide stability while braking as well as while driving.

7. Effective overload and anti-hunt protection can be built into the variable frequency controllers.

8. Eliminating the drive train improves the undercarriage design, including more useful space and a flat floor, and more importantly, also including more flexibility when designing the suspension system.

The advantages listed in 1 through 8 above are significantly reduced if only two wheels are driven. Since the load required to power the vehicle is shared by only two motors instead of four, the size of each motor must be doubled, making it difficult to fit the motors into the wheel rim space. Also, powering only two wheels reduces the effectiveness of the electronic steering control, electronic stability control, and regenerative braking.

1-20. (canceled)

21. I claim a method for creating a mandrel for winding laminating magnetic steel on this mandrel by combining two semi-cylindrical half shafts, where the upper half shaft of the mandrel is reduced in diameter from the diameter of the lower semi-cylindrical half shaft by the thickness of the laminating steel strip, which is wound over the mandrel in order to form a rolled steel strip magnetizable rotor or stator core. A slot 1, FIG. 1B, is created in the lower mandrel for insertion of the beginning (tab) edge 2, FIG. 1A, of the laminating steel strip. When the lower half shaft is positioned under the upper half shaft so its right side is in line with the right side of the upper half shaft, then bolted together, this assembly becomes a mandrel for winding the laminating steel strip around it. The resulting winding of laminating steel strip has a circular shape rather than the undesirable spiral shape of a scroll winding.

22. Regarding the method for creating a mandrel in claim 21, I claim the process of manufacturing a rolled laminated steel strip core by winding a steel strip, whose width is the axial width of the desired laminated rolled strip core, over the mandrel created in Independent claim 1. The length of the strip is determined by the diameter of the desired core. (See FIG. 1A through FIG. 5.)

23. Regarding the method for creating a mandrel in claim 21, I claim the process of manufacturing a rolled laminated steel strip core in which the laminated steel strip core layers are joined together with epoxy or similar means so rigidly that the core's faces can be machined with metal working machinery. This method of manufacturing allows the slots designed to receive the magnet wire to be cut into the face of this laminated steel strip core after the blank (un-perforated) laminated steel strip had been manufactured. (See FIG. 7A through FIG. 7D.)

24. Regarding the method for creating a mandrel in claim 21, I claim the procedure of back wrapping, my technique used to reduce the amount of magnet wire that is not within the slot of the rolled strip core. With this new back wrapping procedure, a measured length of magnet wire is passed through a given slot, then wrapped around the back side of the rolled strip core, then passed through the same slot second time, and thereafter this back wrapping process is continued time after time until the total amount of turns required to be in the entire slot has been installed. (See FIG. 9A through FIG. 14).

25. Regarding the method for creating a mandrel in claim 21, I claim that this invention is capable of attaining multiple speeds by creating multiple winding groups when using the back wrapping technique. These multiple speeds are created by merely reconnecting the back wrapped winding groups; either manually or automatically by the controller. This capability is also possible by back wrapping a conventional stator winding. (See Figures of 9A through FIG. 14)

26. Regarding the method for creating a mandrel in claim 21, I claim the idea of joining the magnetic fields of the left and right stators into one common shared magnetic field. (See FIG. 18.) To accomplish this, both stator fields must rotate in the same direction, with magnetic poles properly aligned to create the magnetic field shown by the arrows in FIG. 18. FIG. 37A and FIG. 37B stators show how the windings must be positioned to properly align both stators. The upper rear stator (or its connections) must be rotated 180 electrical degrees from the lower front stator. The same 180 electrical degree relationship occurs between FIG. 9A and FIG. 9B.

27. Regarding the method for creating a mandrel in claim 21, I claim the use of variable frequency controllers capable of bringing the machine from standstill up to full speed to power iron or steel rotors. When supplied power from a variable frequency controller, the machine can even be used to power these iron or steel rotors, with the possible exception of some two pole motors which might require excessive rotor size. The use of iron or steel rotors make applications of this machine more practical in the field. (See FIG. 22 and other figures.)

28. I claim that by bonding inner and outer copper or aluminum rings to iron and steel rotors, the capacity of the rotors is significantly improved when the power source is a variable frequency controller capable of bringing the motor from standstill up to full speed. This controller can be used to power this copper or aluminum ringed type of rotor, including all two pole motors. (See FIG. 22, and FIGS. 23A through 23c.)

29. Regarding the bonding of inner and outer copper of aluminum to iron and steel rotors in claim 28, I claim the development of two rolled laminating steel stators surrounding one rolled laminating steel squirrel cage type rotor, all of which share one common magnetic field, which can also be described as a brushless doubly fed twin stator multi-phase motor with a rolled laminated steel strip stator and a rolled laminated steel strip squirrel cage type rotor. (See FIG. 24A through FIG. 24C.) The rotor used in these figures is similar to the rotor used in a conventional three-phase induction motor, since it has similar rotor bars which are connected to rotor shorting rings in an identical manner. It can be controlled by connecting it directly to a three phase power supply, or by connecting it to a variable frequency controller capable of bringing the motor from standstill up to a full load. It is capable of handling any load that a conventional three-phase motor with the same rating can handle.

30. Regarding the bonding of inner and outer copper of aluminum to iron and steel rotors in claim 28, I claim that my invention uses a novel type of rotor design where a blank (un-perforated) length of laminating steel is wrapped with epoxy (or other suitable fastener) around a mandrel, forming a rotor core of the proper diameter, after which two shorting rings are pressed both inside and outside this rotor core, all of which are drilled for conducting rods that are then inserted into the core and welded to the shorting rings. (See FIGS. 25A, 25B and 25C.) As mentioned above, this core has two copper or aluminum rings 14 and 15, similar to that used in FIGS. 23A, 23B and 25C installed to the inside and also to the outside of this rotor core. As mentioned above, this assembly of the rings and core is then drilled with multiple holes in predetermined locations, in order to provide holes into which copper or aluminum conducting rods 24 are installed. Welding the rings to the conducting rods creates a simulated squirrel cage rotor. A motor of this type has a performance and characteristics similar to those of FIGS. 24A, 24B, and 24C.

31. Regarding the bonding of inner and outer copper of aluminum to iron and steel rotors in claim 28, I claim that a solid iron or steel core can be substituted for the rolled strip core used in claim 30. (See FIGS. 26A, 26B and 26C.) A motor of this type has a performance and characteristics similar to those of FIGS. 24A, 24B, and 24C with the exception that the motor would need to be supplied by connecting it to a variable frequency controller capable of bringing the motor from standstill up to full load.

32. Regarding the bonding of inner and outer copper of aluminum to iron and steel rotors in claim 28, I claim that this invention provides the capability of a highly efficient, high power factor synchronous motor application for a brushless doubly fed twin stator radial wound electric machine. It is highly efficient with a high power factor because the permanent magnet ring (or individual permanent magnets) provides the common shared magnetic field, which is normally provided by the twin stators. (See FIG. 27.) The controller for this synchronous motor is best supplied by connecting it to a variable frequency controller capable of bringing the motor from standstill up to full load.

33. Regarding the bonding of inner and outer copper of aluminum to iron and steel rotors in claim 28, instead of the conventional use of an iron or steel housing over the stator, I claim the substitution of a strong insulating material such as fiberglass, which is designed to protect the rotor and also to prevent iron, metal or other conducting material from getting close enough to the windings to negatively affect the machine performance. See stator housing, 10, FIGS. 18, 20, 22, 23A to 26A, 27, 29, 30, 31A, and 31B.

34. I claim that this invention consists of a brushless doubly fed twin rotor radial wound electric machine that uses two rotors surrounding one single stator which has two active faces sharing a single winding. (See FIG. 29 and other figures.) This single stator, as shown in FIG. 29 is a variation of FIGS. 23A to 23C. The rotors consist of iron or steel cores which are contained between their bonded inner and outer copper rings. The iron disks 16b carry a portion of the magnetic field created by the single stator. Empty narrow radial slots, 16a are cut part way into the face side of the rotor core between the inner and outer rings. These slots force the rotating magnetic field to expand beyond the slots 16a and into the more permeable iron or steel area, 16b. This expansion of the magnetic field causes this field to cut the iron or steel core between the empty slots, which induces the desired torque producing current through the iron or steel core between the empty slots.

35. Regarding the method of using a brushless doubly fed twin radial wound electric machine that uses two rotors surrounding one single stator with two active faces sharing a single winding in claim 34, I claim a brushless doubly fed twin rotor radial wound electric machine which uses two rotors surrounding one stator. FIG. 30 uses the rolled strip cores of FIG. 33A and FIG. 33B for the rotor. The side view of the rotor of FIG. 30 would be identical to FIG. 33B, which shows slots cut into the rotor's rolled strip core that will be filled with melted metal, in order to create a rotor similar to a conventional squirrel cage induction rotor. The twin rotors have only one active face each, which faces one of the two active faces of the single stator. FIG. 30 shows a simulated squirrel cage 17, embedded in the rolled strip core.

36. Regarding the method of using a brushless doubly fed twin radial wound electric machine that uses two rotors surrounding one single stator with two active faces sharing a single winding in claim 34, I claim a brushless doubly fed twin rotor radial wound electric machine with permanent magnets installed in the twin rotors, surrounds one single stator, thereby creating a synchronous machine. (See FIG. 31) The permanent magnets are backed by an iron or steel back-plate 16c, which supports the permanent magnet and is part of the magnetic circuit. In some cases, a non-magnetic ring 16d is inserted on the inside of the magnets between the magnets and the back-plate 16d. This non-magnetic ring is necessary in some cases to prevent magnetic short-circuiting of the magnetic field.

37. Regarding the method of using a brushless doubly fed twin radial wound electric machine that uses two rotors surrounding one single stator with two active faces sharing a single winding in claim 34, I claim a brushless doubly fed twin rotor radial wound electric machine in which a pair of permanent magnet rings containing the required number of magnetic poles, is installed in the two rotors which surround the stator. (See FIG. 31B.) This permanent magnet ring is anchored to a metal back plate which is not part of the magnetic circuit. The magnetic circuit of the ring is contained within the magnetic ring itself. This method allows a thinner back-plate which in turn results in a thinner electric machine. As in FIG. 31A, a non magnetic ring 16d may also be required here.

38. Regarding the method of using a brushless doubly fed twin radial wound electric machine that uses two rotors surrounding one single stator with two active faces sharing a single winding in claim 34, I claim a brushless doubly fed twin rotor or twin stator radial wound electric machines could have a self-contained cooling system built within them. (See FIGS. 34 and 35) Each system has a self-contained motor consisting of a stator 19b and a rotor 19a. The heat absorbed by the cooling system is carried to the cooling fins 22, where this heat is absorbed by the surrounding atmosphere. In a motor vehicle, a blower attached to the vehicle body could blow air across the cooling fins. FIG. 35 shows a brushless doubly fed twin stator radial wound electric machine which also has a self-contained cooling system built within it. The cooling system is almost identical with the system of FIG. 34, and performs in the same manner.

39. Regarding the method of using a brushless doubly fed twin radial wound electric machine that uses two rotors surrounding one single stator with two active faces sharing a single winding in claim 34, I claim that an overload protection system can be designed to improve overload detection and control. (See FIG. 40) The conventional solution to this overload problem is to use a current sensor that is set to activate at least low enough below the motor failure threshold in order to prevent the overload current from reaching this threshold. Tripping of this overload sensor activates the motor shut down circuit.
An improvement over the solution described above, is the use of software to determine the maximum safe threshold to which the current can rise without causing sudden disruptive motor shut down. This overload detector threshold is deliberately tilted so to its zero speed side is higher than its full speed side. This tilting is necessary in order to cause the controller to immediately lower the speed by lowering the frequency of the motor to a new lower frequency and speed which can handle the high mechanical load on the motor without its current reaching the overload sensor threshold again.
In other words it accomplishes this by instantly dropping down to a lower and lower speed until it finds a speed at which the current no longer is high enough to reach the overload detector threshold. This includes reducing the frequency, and therefore the speed to zero, if the load is still too high. In order to accomplish this task, the software will need input from a speed sensor as well as from a current sensor. Once the cause of the overload has been resolved, the double capacity controller returns the motor back to its selected speed.

40. Regarding the method of using a brushless doubly fed twin radial wound electric machine that uses two rotors surrounding one single stator with two active faces sharing a single winding in claim 34, I claim a brushless doubly fed twin stator rolled steel strip single phase motor can be created in a similar manner to a polyphase motor. The starting windings are connected in series with the capacitor and the centrifugal switch in the same way as in a conventional capacitor start single phase electric motor. Each of the twin stators have start and run windings which operate in the same way as a conventional capacitor start motor. The capacitor causes the current in the starting windings to lead the current in the running winding. This condition produces a revolving magnetic field in the stators which in turn induces a torque producing current in the rotor windings. (See FIG. 41)
A brushless doubly fed twin rotor rolled steel strip single phase motor can also be created in a similar manner to a polyphase motor. Since there is only one stator, its windings are connected in exactly the same manner as a conventional capacitor start motor. Consequently, its performance would be identical to that of a conventional capacitor start motor. (See FIG. 42)
